(19) United States
(12) Patent Application Publication
(10) Pub. No.: US 2024/0412524 A1
(43) Pub. Date: Dec. 12, 2024

(54) TECHNIQUES FOR GENERATING PERSONALIZED SALES PLANS BASED ON REAL-TIME CUSTOMER ACTIVITY

(71) Applicant: William Holloway Petrey, JR., Frisco, TX (US)

(72) Inventors: William Holloway Petrey, JR., Frisco, TX (US); Steven Mason, Las Vegas, NV (US)

(73) Assignee: William Holloway Petrey, JR., Frisco, TX (US)

(21) Appl. No.: 18/742,031

(22) Filed: Jun. 13, 2024

Related U.S. Application Data
(63) Continuation-in-part of application No. 18/518,136, filed on Nov. 22, 2023.
Application No. 18/518,136 is a continuation-in-part of application No. 17/688,340, filed on Mar. 7, 2022, now Pat. No. 11,915,485.
Application No. 17/688,340 is a continuation of application No. 16/910,949, filed on Jun. 24, 2020, now Pat. No. 11,270,129.
(60) Provisional application No. 62/866,278, filed on Jun. 25, 2019.
(60) Provisional application No. 63/606,689, filed on Dec. 6, 2023.

(51) Int. Cl. G06V 20/54; G06V 20/62; G06V 40/16; G08B 7/06; G08B 25/10

(52) U.S. Cl. CPC G06V 20/54; G06V 20/63; G06V 40/161; G08B 7/06; G06V 20/625; G08B 25/10

(57) ABSTRACT

Disclosed herein are techniques for managing proximity-activated customer retail offers (PACROs) for prospective customers of retail stores. According to some embodiments, a technique can be implemented by at least one computing device, and includes the steps of (1) detecting that a prospective customer has satisfied a threshold likelihood of visiting a retail store, (2) obtaining first information associated with the prospective customer, (3) obtaining second information related to offerings associated with the retail store, (4) generating, based on the first and second information, a PACRO for the prospective customer, (5) identifying at least one mechanism through which the prospective customer can be engaged in a manner consistent with the PACRO, and (6) using the at least one mechanism and the PACRO, enabling at least one engagement with the prospective customer.

### CROSS-REFERENCES TO RELATED APPLICATIONS

This application claims priority to and is a continuation-in-part of U.S. patent application Ser. No. 18/518,136 (Attorney Docket No. 85299-116) filed Nov. 22, 2023, entitled “System and Method for Predicting the Presence of an Entity at Certain Locations,” which is a continuation-in-part of U.S. patent application Ser. No. 17/688,340 (Attorney Docket No. 85299-106) filed Mar. 7, 2022, now U.S. Pat. No. 11,915,485, entitled “System and Method for Correlating Electronic Device Identifiers and Vehicle Information,” which is a continuation of U.S. patent application Ser. No. 16/910,949 (Attorney Docket No. 85299-101) filed Jun. 24, 2020, now U.S. Pat. No. 11,270,129, entitled “System and Method for Correlating Electronic Device Identifiers and Vehicle Information,” which claims priority to and the benefit of U.S. Provisional Application Ser. No. 62/866,278 (Attorney Docket No. 85299-100) filed Jun. 25, 2019, the entire disclosures of which are hereby incorporated by reference.

This application also claims priority to and is a conversion of U.S. Provisional Application Ser. No. 63/606,689 (Attorney Docket No. 85299-114) filed Dec. 6, 2023, entitled “Techniques for Generating Personalized Sales Plans Based on Real-Time Customer Activity.”

### TECHNICAL FIELD

This disclosure relates generally to information correlation. More specifically, this disclosure provides techniques for generating personalized sales plans based on real-time customer activity.

### BACKGROUND

Many public and private areas, including airports, business parks, companies, border checkpoints, neighborhoods, etc. employ measures to enhance the safety of the people and property on the area premises. For example, some neighborhoods are gated and visitors to the communities may be forced to check-in with a guard at a security gate prior to being allowed into the neighborhood. Some neighborhoods employ a crime watch group that includes a group of concerned citizens who work together with law enforcement to help keep their neighborhood safe. Such a program may rely on volunteers to patrol the neighborhood to help law enforcement discover and/or thwart suspicious and/or criminal activity. However, these and other conventional measures lack the ability to correlate certain information that provides for enhanced identification, tracking, and notification of and/or to suspicious vehicles/individuals.

Further, selling products and services to prospective customers of brick-and-mortar retailers presents a unique set of challenges that retailers must navigate to thrive in today's dynamic marketplace. For instance, retailers commonly grapple with adapting to shifting consumer behaviors, dealing with substantial price competition posed by online retailers, and managing the inherent complexities of overseeing personnel, inventory, and other aspects of operating physical retail locations.

One of the primary challenges faced by brick-and-mortar retailers is the evolving nature of consumer behavior. For example, the convenience of online shopping has resulted in customers expecting efficient and personalized shopping experiences, which are improving with services such as online recommendations, same day deliveries, and so on. This places considerable pressure on physical retailers to continually adapt their strategies to match these expectations. In particular, retailers must find ways to blend the advantages of an in-person shopping experience with the convenience and personalization offered by their online counterparts.

Significant pricing competition is another hurdle for brick-and-mortar stores, such as competing with e-commerce giants that generally have lower (and, often, significantly lower) overhead with respect to managing physical locations, staffing, and so on. Retailers must also address the challenges posed by “showrooming,” which refers to customers visiting stores merely to evaluate products in person with plans only to purchase them online from a different merchant. Additionally, economic factors, such as recessions and unforeseen events like pandemics, also pose significant challenges. For example, economic downturns can lead to decreased consumer spending and affect the overall health of brick-and-mortar businesses. Further, increased violent crime, pervasive retail theft, the perceived or actual dangers and associated dislike of shopping in areas with problems such as open-air drug use, homelessness, prostitution and the like, a lack of other shoppers in the vicinity, challenges or expenses related to parking and/or public transportation, and related concerns can reduce, sometimes dramatically, customer traffic and the volume of purchases. In another example, the COVID-19 pandemic led to temporary store closures, social distancing measures, and a surge in e-commerce, which underscored the need for physical retail stores to be adaptable.

In sum, it can be challenging for brick-and-mortar retailers to effectively engage with prospective customers who are continually drawn to online shopping avenues. In this regard, it is desirable to establish improved techniques for generating personalized sales plans based on real-time customer activity.

### SUMMARY

In general, the present disclosure provides techniques for generating personalized sales plans based on real-time customer activity.

One embodiment sets forth a method for managing proximity-activated customer retail offers (PACROs) for prospective customers of retail stores. According to some embodiments, the method can be implemented by at least one computing device, and includes the steps of (1) detecting that a prospective customer has satisfied a threshold likelihood of visiting a retail store, (2) obtaining first information associated with the prospective customer, (3) obtaining second information related to offerings associated with the retail store, (4) generating, based on the first and second information, a PACRO for the prospective customer, (5) identifying at least one mechanism through which the prospective customer can be engaged in a manner consistent with the PACRO, and (6) using the at least one mechanism and the PACRO, enabling at least one engagement with the prospective customer.

Another embodiment sets forth a method for generating customized offerings for prospective customers of retail stores. According to some embodiments, the method can be implemented by at least one computing device, and includes the steps of (1) obtaining first information associated with a prospective customer of a retail store, (2) obtaining second information related to extant offerings associated with the retail store, (3) generating, based on the first and second information, third information related to one or more customized offerings for the prospective customer, (4) generating, based on the first and third information, a proximity-activated customer retail offer (PACRO) for the prospective customer, (5) identifying at least one mechanism through which the prospective customer can be engaged in a manner consistent with the PACRO, and (6) using the at least one mechanism and the PACRO, enabling at least one engagement with the prospective customer.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

It should be noted that the term “cellular media access control (MAC) address” may refer to a MAC, international mobile subscriber identity (IMSI), mobile station international subscriber directory number (MSISDN), enhanced network selection (ENS), or any other form of unique identifying number.

### BRIEF DESCRIPTION OF THE DRAWINGS

For a more complete understanding of this disclosure and its advantages, reference is now made to the following description, taken in conjunction with the accompanying drawings, in which:

FIG. 1A illustrates a high-level component diagram of an example of a system architecture, according to certain embodiments of this disclosure;

FIG. 1B illustrates an example of trilateration using the system architecture of FIG. 1A, according to certain embodiments of this disclosure;

FIG. 2 illustrates details pertaining to various components of the system architecture of FIG. 1A, according to certain embodiments of this disclosure;

FIG. 3 illustrates an example of a method for monitoring vehicle traffic, according to certain embodiments of this disclosure;

FIG. 4 illustrates another example of a method for monitoring vehicle traffic, according to certain embodiments of this disclosure;

FIG. 5 illustrates examples of user interfaces presented on computing devices during monitoring vehicle traffic, according to certain embodiments of this disclosure;

FIG. 6 illustrates an example computer system according to certain embodiments of this disclosure;

FIG. 7 illustrates a high-level component diagram of an illustrative system architecture that can be utilized to generate personalized sales plans based on real-time customer activity, as well as generate customized offerings for prospective customers of retail stores, according to certain embodiments of this disclosure;

FIG. 8 illustrates a conceptual diagram of details of the cloud-based computing system of FIG. 7, the retail store computing device of FIG. 7, and the customer activity gathering system of FIG. 7, according to certain embodiments of this disclosure;

FIG. 9 illustrates a method for managing proximity-activated customer retail offers (PACROs) for prospective customers of retail stores, according to certain embodiments of this disclosure;

FIGS. 10A-10I illustrate conceptual diagrams that provide additional context about how the techniques described herein can be utilized, according to certain embodiments of this disclosure;

FIG. 11 illustrates a method for generating customized offerings for prospective customers of retail stores, according to certain embodiments of this disclosure; and

FIGS. 12A-12F illustrate conceptual diagrams that provide additional context about how the techniques described herein can be utilized, according to certain embodiments of this disclosure.

### DETAILED DESCRIPTION

Improvement is desired in the field of public safety for certain areas (e.g., neighborhood, airport, business park, border checkpoint, city, etc.). As discussed above, there are various measures that may be conventionally used, such as gated communities, neighborhood crime watch groups, and so forth. However, the conventional measures lack efficiency and accuracy in identifying suspicious vehicles/individuals and reporting of the suspicious vehicles/individuals, among other things. In some instances, the conventional measures may fail to report the suspicious vehicle/individual, altogether. The causes of the inefficient and/or failed reporting may be at least in part attributable to people (e.g., neighbors in a neighborhood) not having access to verified vehicle and/or personal information of an individual. Further, the conventional measures lack the ability to quickly, accurately, and automatically identify the vehicle as a suspicious vehicle, correlate vehicle information (e.g., license plate identifier (ID)), electronic device information (e.g., electronic device identifier (ID)), face information, etc., and/or perform a preventative action based on the identification.

Take the following example for illustrative purposes. A neighbor may witness an unknown vehicle drive through the neighborhood several times within a given time period during a day. The neighbor may not recognize the license plate ID or driver and may think about reporting the unknown vehicle to law enforcement. Instead, the neighbor may decide to proceed to do another activity. Subsequently, the person may burglarize a house in the neighborhood. Even if the neighbor attempted to lookup the license plate ID, and was able to find out information about an owner of the vehicle, the neighbor may not be able to determine whether the driver of the vehicle is the actual owner, the neighbor may not be able to determine whether the owner or driver is on a crime watch list, and so forth. Further, the neighbor may not be privy to the electronic device identifier of the electronic device the suspicious individual is carrying or that is installed in the vehicle, which may be used to track the whereabouts of the individual/vehicle in a monitored area. Even if a neighbor obtains an electronic device identifier, there currently is no technique for determining personal information associated with the electronic device identifier. To reiterate, conventional techniques for public safety lack the ability to identify a suspicious vehicle/individual and/or to correlate vehicle information, facial information, and/or electronic device identifiers of electronic devices of the driver to make an informed decision quickly, accurately, and automatically.

Aspects of the present disclosure relate to embodiments that overcome the shortcomings described above. The present disclosure relates to a system and method for correlating electronic device identifiers with vehicle information. The system may include one or more license plate detection zones, one or more electronic device detection zones, and/or one or more facial detection zones. The zones may be partially or wholly overlapping and there may be multiple zones established that span a desired area (e.g., a neighborhood, a city block, a public/private parking lot, any street, etc.). The license plate detection zones, the electronic device detection zones, and/or the facial detection zones may include devices that are communicatively coupled to one or more computing systems via a network. The license plate detection zones may include one or more cameras configured to capture images of at least license plates on vehicles that enter the license plate detection zone. The electronic device detection zone may include one or more electronic device identification sensors, such as a Wi-Fi signal detection device or a Bluetooth® signal detection device. The electronic device identification sensors may be configured to detect and store Wi-Fi Machine Access Control (MAC) addresses, Bluetooth MAC addresses, and/or cellular MAC addresses (e.g., International Mobile Subscriber Identity (IMSI), Mobile Station International Subscriber Directory Number (MSISDN), and Electronic Serial Numbers (ESN)) of electronic devices that enter the electronic device detection zone based on the signals emitted by the electronic devices. The facial detection zones may include one or more cameras configured to capture images or digital frames that are used to recognize a face. Any suitable MAC address may be detected, and to that end, a MAC address may be any combination of the IDs described herein (e.g., MAC, MSISIDN, IMSI, ESN, etc.).

The computing system may analyze the images captured by the cameras and detect a license plate identifier (ID) of a vehicle. The license plate ID may be compared with trusted license plate IDs that are stored in a database. When there is not a trusted license plate ID that matches the license plate ID, the computing system may identify the vehicle as a suspicious vehicle. Then, the computing system may correlate the license plate ID of the vehicle with at least one of the stored electronic device identifiers. In some embodiments, the license plate ID and the at least one of the stored electronic device identifiers may be correlated with a face of the individual. In some embodiments, personal information, such as name, address, Bluetooth MAC address, Wi-Fi MAC address, criminal record, whether the suspicious individual is on a crime watch list, etc. may be retrieved using the license plate ID or the at least one of the stored electronic device identifiers that is correlated with the license plate ID of the suspicious vehicle.

The system may include several computer applications that may be accessed by registered users of the system. For example, a client application may be accessed by a computing device of a user, such as a neighbor in a neighborhood implementing the system. The client application may present a user interface including an alert when a suspicious vehicle and/or individual is detected. The user interface may present several preventative actions for the user. For example, the user may contact the suspicious individual using the personal information (e.g., send a threatening text message), notify law enforcement, and so forth. Accordingly, a client application may be accessed by a computing device of a law enforcer. The client application may present a user interface including the notification that a suspicious vehicle and/or individual is detected in the particular zones.

Take the following example of a setup of the system for illustration purposes. In a neighborhood, that may only be accessed by two entrances, license plate detection zones and electronic device detection zones may be placed to cover both lanes at both entrances. In some instances, a facial detection zone may be placed at the entrances with the other zones. Each vehicle may be correlated with each electronic device that enters the neighborhood. Further, the recognized face may be correlated with the electronic device and the vehicle information. The houses inside the neighborhood may setup electronic device detection zones and/or a facial detection zone inside their property to detect electronic device IDs and/or faces and compare them with electronic device IDs and/or faces in a database that stores every correlation that has been made by the system to date (including the most recent correlations of electronic device IDs, faces, and/or vehicles entering the neighborhood). The home owner may be notified via the client application on their computing device if an electronic device and/or face is detected on their property. Further, in some embodiments, the individual associated with the electronic device and/or face may be notified on the electronic device that the homeowner is aware of their presence. If a known criminal with a warrant is detected at either the zones at the entrance or at the zones at the homeowner's property, the appropriate law enforcement agency may be notified of their whereabouts.

The disclosed techniques provide numerous benefits over conventional systems. For example, the system provides efficient, accurate, and automatic identification of suspicious vehicles and/or individuals. Further, the system enables correlating vehicle license plate IDs with electronic device identifiers to enable enhanced detection and/or preventative actions, such as directly communicating with the electronic device of the suspicious individual and/or notifying law enforcement using the client application in real-time or near real-time when the suspicious vehicle enters one or more zones. For example, once the electronic device identifier is detected, a correlation may be obtained with a license plate ID to obtain personal information about the owner that enables contacting the owner directly and/or determining whether the owner is a criminal. The client application provides pertinent information pertaining to both the suspicious vehicle and/or individual in a single user interface without the user having to perform any searches of the license plate ID or electronic device identifier. As such, in some embodiments, the disclosed techniques reduce processing, memory, and/or network resources by reducing searches that the user may perform to find the information. Also, the disclosed techniques provide an enhanced user interface that presents the suspicious vehicle and/or individual information in single location, which may improve a user's experience using the computing device.

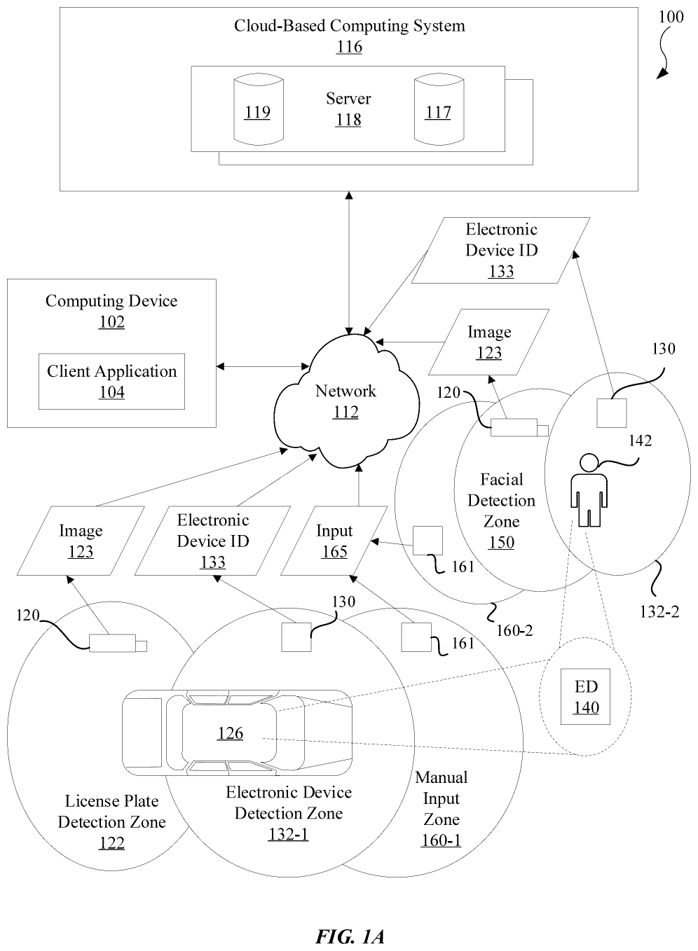

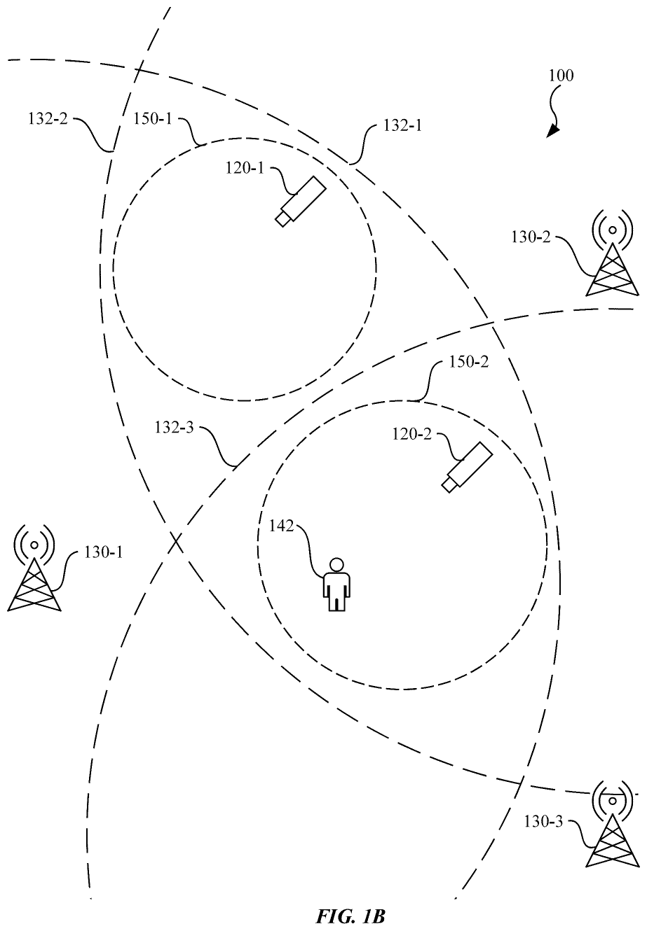

FIG. 1A illustrates a high-level component diagram of a system architecture 100 according to certain embodiments of the present disclosure. In some embodiments, the system architecture 100 may include a computing device 102 communicatively coupled to a cloud-based computing system 116, one or more cameras 120, one or more electronic device identification sensors 130, and/or one or more electronic devices 140 of a suspicious individual. The cloud-based computing system 116 may include one or more servers 118. Each of the computing device 102, the servers 118, the cameras 120, the electronic device identification sensors 130, and the electronic device 140 may include one or more processing devices, memory devices, and network interface devices.

The network interface devices may enable communication via a wireless protocol for transmitting data over short distances, such as Bluetooth, ZigBee, etc. Additionally, the network interface devices may enable communicating data over long distances, and in one example, the computing device 102 may communicate with a network 112. Network 112 may be a public network (e.g., connected to the Internet via wired (Ethernet) or wireless (Wi-Fi)), a private network (e.g., a local area network (LAN) or wide area network (WAN)), or a combination thereof.

The computing device 102 may be any suitable computing device, such as a laptop, tablet, smartphone, or computer. The computing device may be configured to execute a client application 104 that presents a user interface. The client application 104 may be implemented in computer instructions stored on one or more memory devices and executed by one or more processing devices of the computing device 102. The client application 104 may be a standalone application installed on the computing device 102 or may be an application that is executed by another application (e.g., a website in a web browser).

The computing device 102 may include a display that is capable of presenting the user interface of the client application 104. The user interface may present various screens to a user depending on what type of user is logged into the client application 104. For example, a user, such as a neighbor or person interested in one of the license plate detection zones 122 and/or electronic device detection zone 132, may be presented with a user interface for logging into the system where the user enters credentials (username and password), a user interface that displays alerts of suspicious vehicles and/or individuals in the zones 122 and/or 132 where the user interface includes options for preventative actions, a user interface that presents logged events over time, and so forth. For example, the client application 104 may enable the user to directly contact (e.g., send text message, send email, call) the electronic device 140 of a suspicious individual 142 using personal information obtained about the individual 142. Another user, such as a law enforcer, may be presented with a user interface for logging into the system where the user enters credentials (username and password), a user interface that displays notifications when the user selects to notify law enforcement where the notifications may include information related to the suspicious vehicle and/or individual 142.

In some embodiments, the cameras 120 may be located in the license plate detection zones 122. Although just one camera 120 and one license plate detection zone 122 are depicted, it should be noted that any suitable number of cameras 120 may be located in any suitable number of license plate detection zones 122. For example, multiple license plate detection zones 122 may be used to cover a desired area. A license plate detection zone 122 may refer to an area of coverage that is within the cameras' 120 field of view. The cameras 120 may be any suitable camera and/or video camera capable of capturing a set of images 123 that at least represent license plates of a vehicle 126 that enters the license plate detection zone 122. The set of images 123 may be transmitted by the camera 120 to the cloud-based computing system 116 and/or the computing device 102 via the network 112.

In some embodiments, the electronic device identification sensors 130 may be located in the electronic device detection zones 132. In some embodiments, the license plate detection zone 122 and the electronic device detection zone 132-1 may partially or wholly overlap. The combination of license plate detection zones 122 and the electronic device detection zones 132 may be setup at entrances/exits to certain areas, and/or any other suitable area in a monitored area, to correlate each vehicle information with respective electronic device identifiers 133 of electronic devices 140 being carried in respective vehicles 126. Each of the license plate detection zones 122 and electronic device detection zones 132 may have unique geographic identifiers so the data can be tracked by location. It should be noted that any suitable number of electronic device identification sensors 130 may be located in any suitable number of electronic device detection zones 132. For example, multiple electronic device detection zones 132 may be used to cover a desired area. An electronic device detection zone 132 may refer to an area of coverage that is within the electronic device identification sensor 130 detection area.

In one example, an electronic device detection zone 132-2 and/or a facial detection zone 150 may be setup at a home of a homeowner, such that an electronic device 140 and/or a face of a suspicious individual 142 may be detected and stored when the suspicious individual 142 enters the zone 132-2. The electronic device ID 133 and/or an image of the face may be transmitted to the cloud-based computing system 116 or the computing device 102 via the network 112. In some instances, the suspicious individual 142 may be contacted on their electronic device 140 with a message indicating the homeowner is aware of their presence and to leave the premises. In some instances, if a known criminal individual 142 with a warrant is detected at the combination of zones 122 and 132-1 at an entrance or at the zone 132-2 and 150 at the home, then the proper law enforcement agency may be contacted with the whereabouts of the individual 142.

In some embodiments, the cameras 120 may be located in the facial detection zones 150. Although just one camera 120 and one facial detection zone 150 are depicted, it should be noted that any suitable number of cameras 120 may be located in any suitable number of facial detection zones 150. For example, multiple facial detection zones 150 may be used to cover a desired area. A facial detection zone 150 may refer to an area of coverage that is within the cameras' 120 field of view. The cameras 120 may be any suitable camera and/or video camera capable of capturing a set of images 123 that at least represent faces of an individual 142 that enters the facial detection zone 150. The set of images 123 may be transmitted by the camera 120 to the cloud-based computing system 116 and/or the computing device 102 via the network 112. In some embodiments, the cloud-based computing system 116 and/or the computing device 102 may perform facial recognition by comparing a face detected in the image to a database of faces to find a match and/or perform biometric artificial intelligence that may uniquely identify an individual 142 by analyzing patterns based on the individual's facial textures and shape.

The electronic device identification sensors 130 may be configured to detect a set of electronic device IDs 133 (e.g., Wi-Fi MAC addresses, Bluetooth MAC addresses, and/or cellular MAC addresses) of electronic device 140 within the electronic device detection zone 132. As depicted, the electronic device 140 of a suspicious individual is within the vehicle 126 passing through the electronic device detection zone 132. That is, the electronic device identification sensors 130 may be any suitable Wi-Fi signal detection device capable of detecting Wi-Fi MAC addresses and/or Bluetooth signal detection device capable of detecting Bluetooth MAC addresses of electronic devices 140 that enter the electronic device detection zone 132. The set of images 123 may be transmitted by the camera 120 to the cloud-based computing system 116 and/or the computing device 102 via the network 112. The electronic device identification sensor 130 may store the set of electronic device IDs 133 locally in a memory. The electronic device identification sensor 130 may also transmit the set of electronic device IDs 133 to the cloud-based computing system 116 and/or the computing device 102 via the network 112 for storage.

As noted above, the cloud-based computing system 116 may include the one or more servers 118 that form a distributed computing architecture. Each of the servers 118 may be any suitable computing system and may include one or more processing devices, memory devices, data storage, and/or network interface devices. The servers 118 may be in communication with one another via any suitable communication protocol. The servers 118 may each include the database 117 of trusted vehicle license plate IDs, the personal identification database 119, or both. In some implementations, the database 117 of trusted vehicle license plate IDs and the personal identification database 119 may be stored on the computing device 102.

The database 117 of trusted vehicle license plate IDs may be populated by a processing device adding license plate IDs of vehicles that commonly enter the license plate detection zone 122. In some implementations, the database 117 of trusted vehicle license plate IDs may be populated at least in part by manual entry of license plate IDs associated with vehicles trusted to be within the license plate detection zone 122. For example, the license plate IDs may be added at a manual input zone 160-1 using a computing device 161. These license plate IDs may be associated with vehicles owned by neighbors in a neighborhood, or family members of the neighbors, friends of the neighbors, visitors of the neighbors, contractors hired by the neighbors, any suitable person that is trusted, etc.

The personal identification database 119 may be populated by a processing device adding personal identification information associated with electronic device IDs 133 of electronic devices carried by people that commonly enter the electronic device detection zone 132 (e.g., a list of trusted electronic device IDs). In some implementations, the personal identification database 119 may be populated at least in part by manual entry of personal identification information associated with electronic device IDs 133 associated with electronic devices 140 trusted to be within the electronic device detection zone 132 (e.g., a list of trusted electronic device IDs). For example, the personal identification information associated with electronic device IDs 133 may be added at the manual input zone 160-1 using the computing device 161. These electronic device IDs 133 may be associated with electronic devices 140 owned by neighbors in a neighborhood, or family members of the neighbors, friends of the neighbors, visitors of the neighbors, contractors hired by the neighbors, etc. Further, in some implementations, the personal identification database 119 may be populated by entering a list of known suspect individuals from the police department, people entering or exiting border checkpoints, etc.

The personal identification information for untrusted electronic device IDs may also be entered into the personal identification database 119. The personal identification database 119 may also be populated by a processing device adding personal identification information associated with electronic device IDs 133 of electronic devices carried by people that commonly enter the facial detection zone 132 (e.g., face images of trusted individuals). The face images 123 may be manually entered at manual input zone 160-2 using the computing device 161. The personal identification information may include names, addresses, faces, email addresses, phone numbers, electronic device identifiers associated with electronic devices owned by the people (e.g., Bluetooth MAC addresses, Wi-Fi MAC addresses), correlated license plate IDs with the electronic device identifiers, etc. The correlations between the license plate IDs, the electronic device identifiers, and/or the faces may be performed by a processing device using the data obtained from the cameras 120 and the electronic device identification sensors 130. Some of this information may be obtained from public sources, phone books, the Internet, and/or companies that distribute electronic devices. In some implementations, the personal identification information added to the personal identification database 119 may be associated with people selected based on their residing in or near a certain radius of a geographic region where the zones 122 and/or 132 are set up, based on whether they are on a crime watch list, or the like.

In some implementations, the system 100 uses overlapping detection zones of multiple electronic device identification sensors to narrow the location area of an individual. For example, in FIG. 1B, the three detection zones 132-1, 132-2, and 132-3 of the three electronic device identification sensors 130-1, 130-2, and 130-3 partially overlap with each other. Further, the individual 142 in FIG. 1B is positioned within the overlapping portions of the three detection zones 132-1, 132-2, and 132-3. Thus, when all three electronic device identification sensors 130-1, 130-2, and 130-3 detect an electronic device carried by the individual 142, the system 100 may determine that the individual 142 is located within the overlapping portions of the three detection zones 132-1, 132-2, and 132-3.

In some implementations, the system 100 may further narrow the location area of the individual 142 using trilateration (or multilateration). Each of the three electronic device identification sensors 130-1, 130-2, and 130-3 may determine, based on the signal strength of the electronic device carried by the individual 142, the distance to the individual 142. For example, electronic device identification sensor 130-2 may determine that the electronic device carried by the individual 142 is close to electronic device identification sensor 130-2 when the signal strength is strong or determine that the electronic device is far from electronic device identification sensor 130-2 when the signal strength is weak. Alternatively, or in addition, each of the three electronic device identification sensors 130-1, 130-2, and 130-3 may determine the distance to the individual 142 by measuring the time delay that a signal takes to return to the electronic device identification sensors 130-1, 130-2, and 130-3 from the electronic device carried by the individual 142. For example, electronic device identification sensor 130-3 may determine that the electronic device carried by the individual 142 is close to electronic device identification sensor 130-3 when the time delay is short or determine that the electronic device is far from electronic device identification sensor 130-3 when the time delay is long. “Short” and “long,” as used in the foregoing may refer to any amount of time delay without restriction, so long that the constraint, in any given instance, is that a long time delay be for a greater period of time than a short time delay. The system 100 may, based on the locations of each of the three electronic device identification sensors 130-1, 130-2, and 130-3 and the distances from the electronic device to each of the three electronic device identification sensors 130-1, 130-2, and 130-3, determine the coordinates of the electronic device. For example, the system 100 may determine the coordinates of the electronic device using the follow equations:

$$x = \frac{\begin{matrix}( {r}_{1}^{2} - {r}_{2}^{2} - {x}_{1}^{2} + {x}_{2}^{2} - {y}_{1}^{2} + {y}_{2}^{2} ) ( 2 {y}_{3} - 2 {y}_{3} ) - \\ ( {r}_{2}^{2} - {r}_{3}^{2} - {x}_{2}^{2} + {x}_{3}^{2} - {y}_{2}^{2} + {y}_{3}^{2} ) ( 2 {y}_{2} - 2 {y}_{1} )\end{matrix}}{( 2 {y}_{3} - 2 {y}_{3} ) ( 2 {x}_{2} - 2 {x}_{1} ) - ( 2 {y}_{2} - 2 {y}_{1} ) ( 2 {x}_{3} - 2 {x}_{2} )} \\ y = \frac{\begin{matrix}( {r}_{1}^{2} - {r}_{2}^{2} - {x}_{1}^{2} + {x}_{2}^{2} - {y}_{1}^{2} + {y}_{2}^{2} ) ( 2 {x}_{3} - 2 {x}_{2} ) - \\ ( 2 {x}_{2} - 2 {x}_{1} ) ( {r}_{2}^{2} - {r}_{3}^{2} - {x}_{2}^{2} + {x}_{3}^{2} - {y}_{2}^{2} + {y}_{3}^{2} )\end{matrix}}{( 2 {y}_{2} - 2 {y}_{1} ) ( 2 {x}_{3} - 2 {x}_{2} ) - ( 2 {x}_{2} - 2 {x}_{1} ) ( 2 {y}_{3} - 2 {y}_{2} )}$$

wherein:
x, y=coordinates of the electronic device carried by the individual 142;
x₁, y₁=coordinates of electronic device identification sensor 130-1;
r₁=distance between electronic device identification sensor 130-1 and the electronic device;
x₂, y₂=coordinates of electronic device identification sensor 130-2;
r₂=distance between electronic device identification sensor 130-2 and the electronic device;
x₃, y₃=coordinates of electronic device identification sensor 130-3; and
r₃=distance between electronic device identification sensor 130-3 and the electronic device.

Alternatively, or in addition, the system 100 may further narrow the location area of the individual 142 by selecting a different type of detection device located within the overlapping portions of the three detection zones 132-1, 132-2, and 132-3. For example, there are two cameras 120-1 and 120-2 in FIG. 1B with different facial detection zones 150-1 and 150-2. When all three electronic device identification sensors 130-1, 130-2, and 130-3 detect an electronic device carried by the individual 142, the system 100 may select camera 120-2 with facial detection zone 150-2 that is located within the overlapping portions of the three detection zones 132-1, 132-2, and 132-3. The selected camera 120-2 may then detect the location of the individual 142 within facial detection zone 150-2.

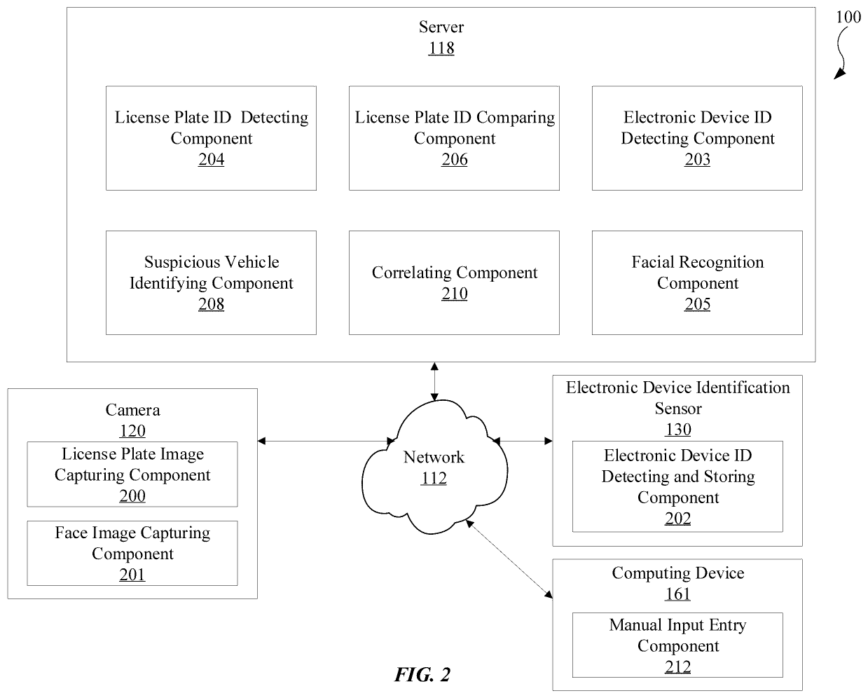

FIG. 2 illustrates details pertaining to various components of the system architecture 100 of FIG. 1A, according to certain embodiments of the present disclosure. For example, the camera 120 includes an image capturing component 200 and a face image capturing component 201; the electronic device identification sensor 130 includes an electronic device ID detecting and storing component 202; the server 118 includes an electronic device ID detecting component 203, a license plate ID detecting component 204, a facial recognition component 205, a license plate ID comparing component 206, a suspicious vehicle identifying component 208, and a correlating component 210. In some embodiments, the computing device 161 includes a manual input entry component 212. In some embodiments, the components 203, 204, 205, 206, 208, and 210 may be included in the computing device 102 executing the client application 104. Each of the components 200, 201, 202, 203, 204, 205, 206, 208, 210, and 212 may be implemented in computer instructions stored on one or more memory devices of their respective device and executed by one or more processors of their respective device.

With regards to the image capturing component 200, the component 200 may be configured to capture a set of images 123 within a license plate detection zone 122. At least some of the captured images 123 may represent license plates of a set of vehicles 126 appearing within the field of view of the cameras 120. The image capturing component 200 may configure one or more camera properties (e.g., zoom, focus, etc.) to obtain a clear image of the license plates. The image capturing component 200 may implement various techniques to extract the license plate ID from the images 123, or the image capturing component 200 may transmit the set of images 123, without analyzing the images 123, to the server 118 via the network 112.

With regards to the electronic device ID detecting and storing component 202, the component 202 may be configured to detect and store a set of electronic device IDs 133 of electronic devices located within one or more electronic device detection zones 132. The electronic device ID detecting and storing component 202 may detect a Wi-Fi signal, cellular signal, and/or a Bluetooth signal from the electronic device and be capable of obtaining the Wi-Fi MAC address, cellular MAC address, and/or Bluetooth MAC address of the electronic device from the signal. The electronic device IDs 133 may be stored locally in memory on the electronic device identification sensor 130, and/or transmitted to the server 118 and/or the computing device 102 via the network 112.

With regards to the license plate ID detecting component 204, the component 204 may be configured to detect, using the set of images 123, a license plate ID of a vehicle 126. The license plate ID detecting component 204 may perform optical character recognition (OCR), or any suitable identifier/text extraction technique, on the set of images 123 to detect the license plate IDs.

With regards to the license plate ID comparing component 206, the component 206 may be configured to compare the license plate ID of the vehicle to a database 117 of trusted vehicle license plate IDs. The license plate ID comparing component 206 may compare the license plate ID with each trusted license plate ID in the database 117 of trusted vehicle license plate IDs.

With regards to the suspicious vehicle identifying component 208, the component 208 may identify the vehicle 126 as a suspicious vehicle 126, the identification based at least in part on the comparison of the license plate ID of the vehicle 126 to the database 117 of trusted vehicle license plate IDs. If there is not a trusted license plate ID that matches the license plate ID of the vehicle 126, then the suspicious vehicle identifying component 208 may identify the vehicle as a suspicious vehicle.

With regards to the correlating component 210, the component 210 may be configured to correlate the license plate ID of the vehicle 126 with at least one of the set of stored electronic device IDs 133. Correlating the license plate ID of the vehicle 126 with at least one of the set of stored electronic device IDs 133 may include comparing one or more time stamps of the set of captured images 123 with one or more time stamps of the set of stored electronic device IDs 133. Also, correlating the license plate ID of the vehicle 126 with at least one of the set of stored electronic device IDs 133 may include analyzing at least one of: (i) at least one strength of signal associated with at least one of the set of stored electronic device IDs 133, and (ii) at least one visually estimated distance of at least one vehicle 126 associated with at least one of the set of stored images 123.

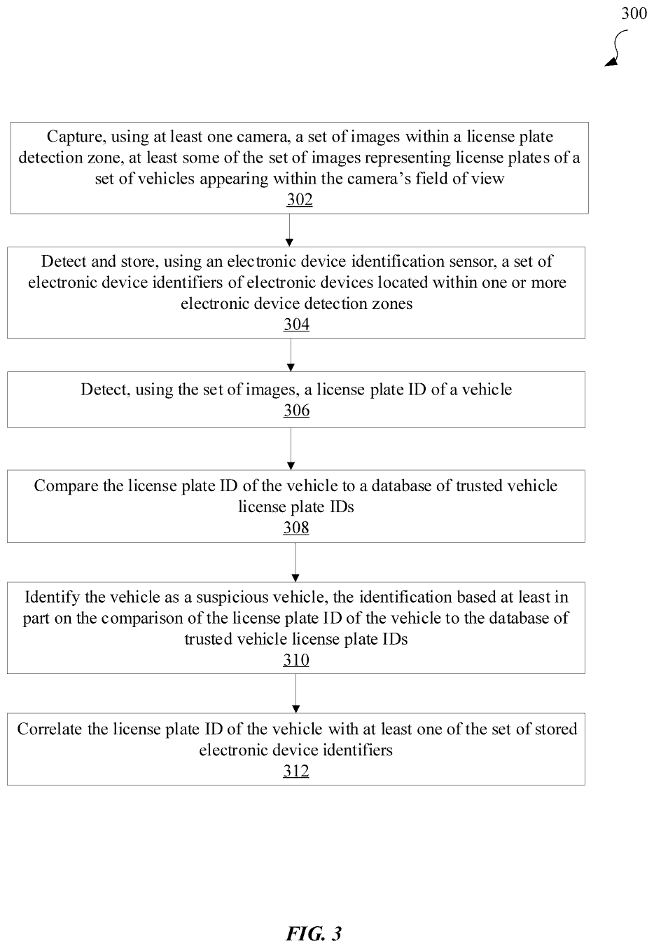

FIG. 3 illustrates an example of a method 300 for monitoring vehicle traffic, according to certain embodiments of this disclosure. The method 300 may be performed by processing logic that may include hardware (circuitry, dedicated logic, etc.), firmware, software, or a combination of both. The method 300 and/or each of their individual functions, subroutines, or operations may be performed by one or more processors of one or more of the devices in FIG. 1A (e.g., computing device 102, cloud-based computing system 116 including servers 118, cameras 120, electronic device identification sensors 130) implementing the method 300. For example, a computing system may refer to the computing device 102 or the cloud-based computing system 116. The method 300 may be implemented as computer instructions that, when executed by a processing device, execute the operations. In certain implementations, the method 300 may be performed by a single processing thread. Alternatively, the method 300 may be performed by two or more processing threads, each thread implementing one or more individual functions, routines, subroutines, or operations of the method 300.

At block 302, a set of images 123 may be captured, using at least one camera 120, within a license plate detection zone 122. At least some of the set of images 123 may represent license plates of a set of vehicles 126 appearing within the camera's field of view. One or more camera properties (e.g., zoomed in, focused, etc.) may be configured to enable the at least one instance of the camera 120 to obtain clear images 123 of the license plates.

At block 304, a set of electronic device identifiers 133 of electronic devices 140 located within one or more electronic device detection zones 132 may be detected and stored using an electronic device identification sensor 130. In some implementations, the electronic device identification sensor 130 may include at least one of a Wi-Fi signal detection device, cellular signal detection device, or a Bluetooth signal detection device. In some embodiments, the set of electronic device identifiers 133 may include at least one of a Bluetooth MAC address, cellular MAC address, or a Wi-Fi MAC address. In some embodiments, at least one of the set of stored electronic device identifiers 133 may be compared with a list of trusted device identifiers.

At block 306, a license plate ID of a vehicle 126 may be detected using the set of images 123. The images 123 may be filtered, rendered, and/or processed in any suitable manner such that the license plate IDs may be clearly detected using the set of images 123. In some embodiments, object character recognition (OCR) may be used to detect the license plate IDs in the set of images 123. The OCR may electronically convert each image in the set of images 123 of the license plate IDs into computer-encoded license plate IDs that may be stored and/or used for comparison.

In some embodiments, a face of the individual 142 may be detected by a camera 120 in the facial detection zone 150. An image 123 may be captured by the camera 120 and facial recognition may be performed on the image to detect the face of the individual. The detected face and/or the image 123 may be transmitted to the cloud-based computing system 116 and/or the computing device 102.

At block 308, the license plate ID of the vehicle 126 may be compared to a database of trusted vehicle license plate IDs. In some implementations, the database 117 of trusted vehicle license plate IDs may be populated at least in part by adding license plate IDs of vehicles 126 that commonly enter the license plate detection zone 122 to the database 117 of trusted vehicle license plate IDs. In some implementations, the database 117 of trusted vehicle license plate IDs may be populated at least in part by manual entry of license plate IDs associated with vehicles 126 trusted to be within the license plate detection zone 122. For example, the trusted vehicles may belong to the neighbors, family members of the neighbors, friends of the neighbors, law enforcement, and so forth.

At block 310, the vehicle may be identified as a suspicious vehicle 126. The identification may be based at least in part on the comparison of the license plate ID of the vehicle to the database 117 of trusted vehicle license plate IDs. For example, if the license plate ID is not matched with a trusted license plate ID stored in the database 117 of trusted vehicle license plate IDs, then the vehicle associated with the license plate ID may be identified as a suspicious vehicle 126.

At block 312, the license plate ID of the vehicle 126 may be correlated with at least one of the set of stored electronic device identifiers 133. In some implementations, the face of the individual 142 may also be correlated with the license plate ID and the at least one of the set of stored electronic device identifiers 133. In some embodiments, the personal identification database 119 may be accessed. In some embodiments, correlating the license plate ID of the vehicle 126 with at least one of the set of stored electronic device identifiers 133 may include comparing one or more time stamps of the set of captured images 123 with one or more time stamps of the set of stored electronic device identifiers 133. In some embodiments, correlating the license plate ID of the vehicle 126 with the at least one of the set of stored electronic device identifiers 133 may include analyzing at least one of (i) at least one strength of signal associated with at least one of the set of stored electronic device identifiers 133, and (ii) at least one visually estimated distance of at least one vehicle associated with at least one of the set of stored images 123.

Personal identification information of at least one suspicious individual may be retrieved from the personal identification database 119 by correlating information of the personal identification database 119 with the license plate ID of the vehicle 126 or at least one of the set of electronic device identifiers 133 correlated with the license plate ID of the vehicle 126. The personal identification information may also be obtained using a face detected by the camera 120 to obtain the electronic device ID 133 and/or the license plate ID correlated with the face. The personal identification information may include one or more of a name, a phone number, an email address, a residential address, a Bluetooth MAC address, a cellular MAC address, a Wi-Fi MAC address, whether the suspicious individual is on a crime watch list, a criminal record of the suspicious individual, and so forth.

In some embodiments, a user interface may be displayed on one or more computing devices 102 of one or more neighbors when the one or more computing devices are executing the client application 104, and the user interface may present a notification or alert. In some embodiments, the computing device 102 may present a push notification on the display screen and the user may provide user input (e.g., swipe the push notification) to expand the notification on the user interface to a larger portion of the display screen. The alert or notification may indicate that there is a suspicious vehicle 126 identified within the license plate detection zone 122 and/or the electronic device detection zone 132-1 and may provide information pertaining to the vehicle 126 (e.g., make, model, color, license plate ID, etc.) and personal identification information of the suspicious individual (e.g., name, phone number, email address, Bluetooth MAC address, cellular MAC address, Wi-Fi MAC address, whether the individual is on a crime watch list, whether the individual has a criminal record, etc.).

Further, the user interface may present one or more options to perform preventative actions. The preventative actions may include contacting an electronic device 140 of the suspicious individual using the personal identification information. For example, a user may use a computing device 102 to transmit a communication (e.g., at least one text message, phone call, email, or some combination thereof) to the suspicious individual using the retried personal information.

In addition, the preventative actions may also include notifying law enforcement of the suspicious vehicle and/or individual. This preventative action may be available if it is determined that the suspicious individual is on a crime watch list. A suspicious vehicle profile may be created. The suspicious vehicle profile may include the license plate ID of the suspicious vehicle and/or the at least one correlated electronic device identifiers (e.g., Bluetooth MAC address, Wi-Fi MAC address). The user may select the notify law enforcement option on the user interface and the computing device 102 of the user may transmit the suspicious vehicle profile to another computing device 102 of a law enforcement entity that may be logged into the client application 104 using a law enforcement account.

In some embodiments, the preventative action may include activating an alarm upon detection of the suspicious vehicle 126. The alarm may be located in the neighborhood, for example, on a light pole, a tree, a pole, a sign, a mailbox, a fence, or the like. The alarm may be included in the computing device 102 of a user (e.g., a neighbor) using the client application. The alarm may include auditory (e.g., a message about the suspect, a sound, etc.), visual (e.g., flash certain colors of lights), and/or haptic (e.g., vibrations) elements. In some embodiments, the severity of the alarm may change the pattern of auditory, visual, and/or haptic elements based on what kind of crimes the suspicious individual has committed, whether the suspicious vehicle 126 is stolen, whether the suspicious vehicle 126 matches a description of a vehicle involved in an Amber alert, and so forth.

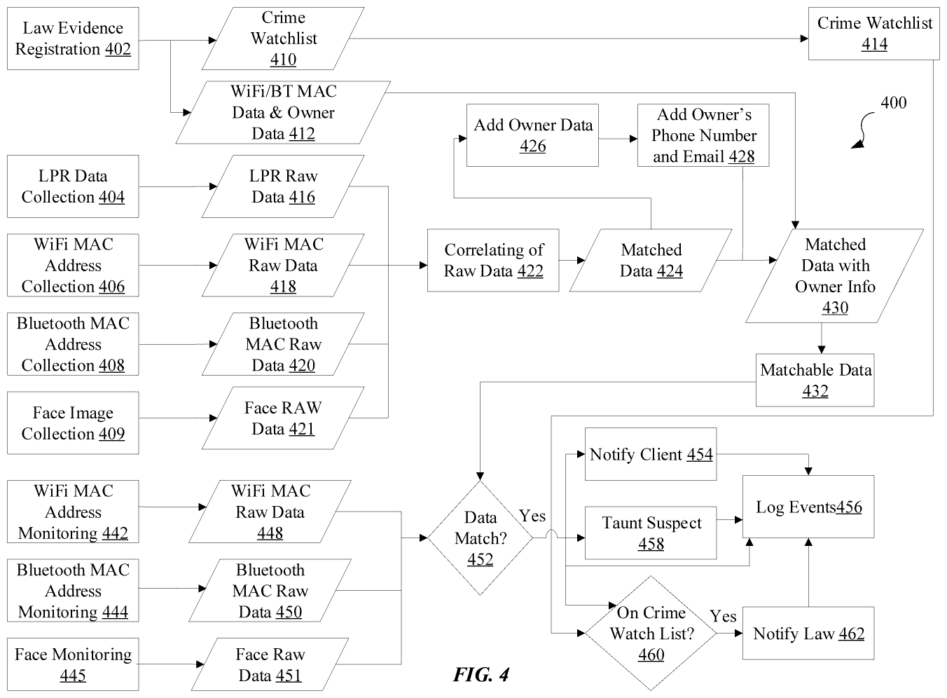

FIG. 4 illustrates another example of a method 400 for monitoring vehicle traffic, according to certain embodiments of this disclosure. Method 400 includes operations performed by one or more processing devices of one or more devices in FIG. 1A (e.g., computing device 102, cloud-based computing system 116 including servers 118, cameras 120, electronic device identification sensors 130) implementing the method 400. In some embodiments, one or more operations of the method 400 are implemented in computer instructions that, when executed by a processing device, execute the operations of the steps. The method 400 may be performed in the same or a similar manner as described above in regards to method 300.

The method 400 may begin with a setup phase where various blocks 402, 404, 406, 408, and/or 409 are performed to register data that may be used to determine whether a vehicle and/or individual is suspicious. For example, at block 402, law evidence may be registered. The law evidence may be obtained from a system of a law enforcement agency. For example, an application programming interface (API) of the law enforcement system may be exposed and API operations may be executed to obtain the law evidence. The law evidence may indicate whether a person is on a crime watch list 410, whether the person has a warrant, whether person has a criminal record, and/or the Wi-Fi/Bluetooth MAC data (address)/cellular data of electronic devices involved in incidents, as well as the owner data 412 of the electronic devices. The crime watch list 410 information may be used to store crime watch list 414 in a database (e.g., personal identification database 119).

At block 404, license plate registration (LPR) data may be collected using the one or more cameras 120 in the license plate detection zones 122 as LPR raw data 416. The LPR raw data 416 may be used to obtain vehicle owner information (e.g., name, address, phone number, email address) and vehicle information (e.g., license plate ID, make, model, color, year, etc.). For example, the LPR raw data 416 may include at least the license plate ID, which may be used to search the Department of Motor Vehicles (DMV) to obtain the vehicle owner information and/or vehicle information. In some instances, the LPR raw data 416 may be collected from manual entry. At block 406, Wi-Fi MAC addresses may be collected from various sources as Wi-Fi MAC raw data 418. For example, the Wi-Fi MAC raw data 418 may be collected from the electronic device identification sensors 130 in the electronic device detection zones 132. In some instances, trusted Wi-Fi MAC addresses may be manually obtained from certain people owning electronic devices in an area covered by the electronic device detection zones 132 and stored in a database (e.g., personal identification database 119). In some implementations, cellular raw data (e.g., cellular MAC addresses) may be collected from electronic device identification sensors 130. At block 408, Bluetooth MAC addresses may be collected from various sources as Bluetooth MAC raw data 420. For example, the Bluetooth MAC raw data 420 may be collected from the electronic device identification sensors 130 in the electronic device detection zones 132. In some instances, trusted Bluetooth MAC addresses may be manually obtained from certain people owning electronic devices in an area covered by the electronic device detection zones 132 and stored in a database (e.g., personal identification database 119). In some embodiments, the Bluetooth MAC addresses may be collected from the electronic device identification sensors 130 at the electronic device detection zones 132. At block 409, face images may be collected as face raw data 421 by the one or more cameras 120 in the facial detection zones 150. Facial recognition may be performed to detect and recognize faces in the face images.

At block 422, the LPR raw data 416, the Wi-Fi MAC raw data 418, the Bluetooth MAC raw data 420, the cellular raw data, and/or the face raw data 421 may be correlated or paired to generate matched data 424. That is, the data from license plate ID detection, LPR systems, personal electronic device detection, and/or facial information may be combined to generate matched data 424 and stored in the database 117 of trusted vehicle license plate IDs and/or the personal identification database 119. In some embodiments, the license plate IDs are compared to the personal identification database 119 of trusted vehicle license plate IDs to determine whether the detected license plate ID is in the database 117 of trusted vehicle license plate IDs. If not, the vehicle 126 may be identified as a suspicious vehicle and the license plate ID of the vehicle may be correlated with at least one of the set of stored electronic device IDs 133. This may result in creation of a database of detected electronic device identifiers 133 correlated with license plate IDs and facial information of individuals. Any unpaired data may be discarded after unsuccessful pairing.

At block 426, owner data of the electronic devices and/or vehicle may be added to the matched data 424. The owner data may include an owner ID, and/or name, address, and the like. Further, at block 428, owner's phone number and email may be added to the matched data. In addition, Wi-Fi/Bluetooth MAC/cellular data and owner data 412 from the law evidence may be included with the matched data 424 and the personal information of the owner to generate matched data with owner information 430. Accordingly, the owner ID may be associated with combined personal information (e.g., name, address, phone number, email, etc.), vehicle information (e.g., license plate ID, make, model, color, year, vehicle owner information, etc.), and electronic device IDs 133 (e.g., Wi-Fi MAC address, Bluetooth MAC adder). At block 432, the matched data with owner information 430 may be further processed (e.g., formatted, edited, etc.) to generate matchable data. This may conclude the setup phase.

Next, the method 400 may include a monitoring phase. During this phase, the method 400 may include blocks 442, 444, and 445. At block 442, Wi-Fi MAC address monitoring may include one or more electronic device identification sensors 130 detecting and storing a set of Wi-Fi MAC addresses as Wi-Fi MAC raw data 448. In some embodiments, cellular signal monitoring may include one or more electronic device identification sensors 130 detecting and storing a set of cellular MAC addresses as cellular raw data. At block 444, Bluetooth MAC address monitoring may include one or more electronic device identification sensors 130 detecting and storing a set of Bluetooth MAC addresses as Bluetooth MAC raw data 450. At block 445, face monitoring may include the one or more cameras 120 capturing face images and recognizing faces in the face images as face raw data 451. The Wi-Fi MAC raw data 448, Bluetooth MAC raw data 450, and/or face raw data 451 may be compared to matchable data at block 452.

At block 452, the electronic device IDs 133 and/or faces detected by the electronic device identification sensors 130 and/or the cameras 120 may be compared to the matchable data. The matchable data may include personal identification information that is retrieved from at least the personal identification database 119. That is, the detected electronic device IDs 133 and/or faces may be compared to the database 117 of trusted vehicle license plate IDs and/or the personal identification database 119 to find any correlation of the detected electronic device IDs 133 and/or faces with license plate IDs.

If there is a matching electronic device ID to the detected electronic device ID and/or a matching face to the detected face, and there is a correlation with a license plate ID in the database 117 of trusted vehicle license plate IDs and/or the personal identification database 119, then a suspicious vehicle 126/individual 143 may be detected. At block 456, the detected match event may be logged. At block 454, the user interface of the client application 104 executing on the computing device 102 may present an alert of the suspicious vehicle 126/individual 142. At block 456, the detected notification event may be logged. At block 458, the electronic device 140 of the suspicious individual 142 may be notified that his presence is known (e.g., taunted). At block 456, the taunting event may be logged.

At decision block 460, the crime watch list 414 may be used to determine if the identified individual 142 is on the crime watch list 414 using the individual's personal information. If the individual 142 is on the watch list 414, then at block 462, the appropriate law enforcement agency may be notified. At block 456, the law enforcement agency notification event may be logged.

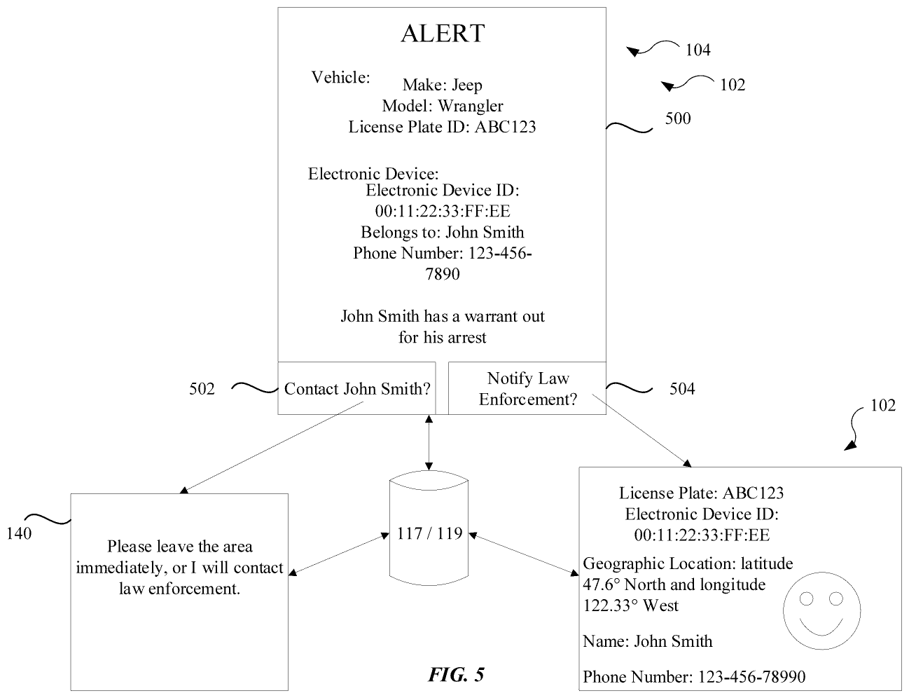

FIG. 5 illustrates example use interfaces presented on computing devices during monitoring vehicle traffic, according to certain embodiments of this disclosure. It should be noted that a user interface 500 may present vehicle information and electronic device information in a single user interface. When a suspicious vehicle 126/individual 142 is detected based on the vehicle license plate ID and/or the electronic device IDs 133, a notification may be presented on the user interface 500 of the client application 104 executing on the computing device 102 of a user (e.g., homeowner, neighbor, interested citizen). As depicted, the notification includes an alert displaying vehicle information and electronic device information. The vehicle information includes the “Make: Jeep”, “Model: Wrangler”, “License Plate ID: ABC123.” The electronic device information includes “Electronic Device ID: 00:11:22:33:FF:EE”, “Belongs to: John Smith”, “Phone Number: 123-456-7890.” Further, the user interface 500 presents that the owner has a warrant out for his arrest. The notification event may be logged in the database 117/119 or any suitable database of the system architecture 100.

The user interface 500 includes various preventative action options represented by user interface element 502 and 504. For example, user interface element 502 may be associated with contacting the detected suspicious individual 142 directly. Upon selection of the user interface element 502, the user may be able to send a text message to the electronic device 140 of the suspicious individual 142. For example, the text message may read “Please leave the area immediately, or I will contact law enforcement.” However, any suitable message may be sent. The message/taunting event may be logged in the database 117/119 or any suitable database of the system architecture 100.

Since the suspicious individual 142 has a warrant out for his arrest and/or is on a crime watch list, the user interface element 504 may be displayed that provides the option to notify law enforcement. Upon selection of the user interface element 504, a notification may be transmitted to a computing device 102 of a law enforcement agency. The notification may include vehicle information (e.g., “License Plate ID: ABC123”), electronic device information (e.g., “Electronic Device ID: 00:11:22:33:FF:EE”), as well as location of the detection (e.g., “Geographic Location: latitude 47.6° North and longitude 122.33° West”), and personal information (“Name: John Smith”, “Phone Number: 123-456-7890”, a face of the individual 142). The law enforcement agency event may be logged in the database 117/119 or any suitable database of the system architecture 100.

Below are example data tables that may be used to implement the system and method for monitoring vehicle traffic disclosed herein. The data tables may include: Client and ID Tables (logID, loginAttempts, clientUser, lawUser, billing), Data Site Info (monitoredSites, dataSites, dataGroups), Raw Collection Data (rawWiFiDataFound, rawBTDataFound, rawLPRDataFound, pairedData), Monitor Data Raw & Matched (monWiFiDataDetected, monBTDataDetected, mon WiFiDataMatched, monBTDataMatched), Subject Data (subjectMatch, subjectInfo, subjectLastSeen, criminalWatchList), Notification Logs (subNotifyLog, subNotifyReplyLog, clientNotifyLog).

TABLE 1
loginID
loginID
username
clientID
idType
rights
email
password
lastLogin

Table 1: logID is used for login ID/passwords, authentication and password resets

TABLE 2
loginAttempts
loginAttempts
clientID
username
timeStamp
IP
wifiRSSI
wifiVendor
wifiLocDet
scanInt

Table 2: loginAttempts logs the number of times logins were attempted for both successes and failures

TABLE 3
clientUser
clientUser
clientID
username
firstName
lastName
phone1
phone2
phone3
email1
email2
email3
txt1
txt2
txt3
lastUserName
dataIDs
lawID
monID

Table 3: clientUser includes information for each user.

TABLE 4
lawUser
lawUser
lawUserName
lawID
lawType
lawPrecinct
lawDept
firstName
lastName
phone1
phone2
phone3
email1
email2
email3
txt1
txt2
Txt3
alertType

Table 4: lawUser includes information for law enforcement persononel wanting to be notified of suspicious vehicles 126/individuals 142.

TABLE 5
billing
billing
clientID
username
package
numMons
options
cardType
cardName
cardAddr1
cardAddr2
cardCity
cardState
cardZIP
cardNum
cardExp
cardID

Table 5: billing may be used for third-party billing.

TABLE 6
monitoredSites
monitoredSites
monID
monGroupID
clientID
monAddr1
monAddr2
monCity
monState
monZIP
monCountry

Table 6: monitoredSites includes information for WiFi/Bluetooth monitoring for detection, among other things.

TABLE 7
dataSites
dataSites
dataID
dataAddr1
dataAddr2
dataCity
dataState
dataZIP
dataCountry
groupNum
hwModel
hwSerialNum
softVersion
installDate
devLoc
notes

Table 7: dataSites includes information for WiFi/Bluetooth/License Plate Registration detection sites. These sites may supply data to databases, among other things.

TABLE 8
dataGroups
dataGroups
groupID
groupName
groupLocation
groupAddr1
groupAddr2
groupCity
groupState
groupZIP
groupCountry
info

Table 8: dataGroups may group data groups and monitored sites. Groupings such as Homeowner Associations, neighborhoods, etc.

TABLE 9
rawWiFiDataFound
rawWiFiDataFound

timeStamp
wifiSync
wifiMAC
wifiDevice
wifiRSSI
wifiVendor
wifiLocDet
scanInt

Table 9: raw WiFiDataFound includes raw data dump for WiFi from detection sites used to look for matches.

TABLE 10
rawBTDataFound
rawBTDataFound

timeStamp
btSync
btMAC
btName
btRSSI
btVendor
btCOD
btLocDet
scanInt

Table 10: rawBTDataFound includes raw data dump for Bluetooth from detection sites used to look for matches.

TABLE 11
rawLPRDataFound
rawLPRDataFound

| | |
|---|---|
| timeStamp | lprPic3 |
| lprPlate | lprPic4 |
| lprState | lprPic5 |
| lpreMake | lprPic6 |
| lprModel | lprPic7 |
| lprPlatePic | lprPic8 |
| lprPic1 | lprLocDet |
| lprPic2 | scanInt |

Table 11: rawLPRDataFound may include raw LPR data from detection sites used to look for matches.

TABLE 12
pairedData
pairedData

| | |
|---|---|
| pairedID | btCOD |
| timeStamp | wifiLocDet |
| lprTimeStamp | btLocDet |
| wifiTimeStamp | lprLocDet |
| btTimeStamp | lprPlatePic |
| lprPlate | lprPic1 |
| lprState | lprPic2 |
| lprMake | lprPic3 |
| lprModel | lprPic4 |
| wifiMAC | lprPic5 |
| wifiDevice | lprPic6 |
| wifiVendor | lprPic7 |
| btMAC | lprPic8 |
| btName | subjectID |
| btVendor | |

Table 12: pairedData includes matched data that may be the correlation between vehicle information (e.g., license plate IDs) and electronic device IDs 133.

TABLE 13
monWiFiDataDetected
monWiFiDataDetected

timestamp
wifiSync
wifiMAC
wifiDevice
wifiRSSI
wifiVendor
wifiMonLoc

Table 13: monWiFiDataDetected logs of any MAC address data detected before matching for WiFi.

TABLE 14
monBTDataDetected
monBTDataDetected

timestamp
btSync
btMAC
btName
btRSSI
btVendor
btCOD

Table 14: monBTDataDetected logs of any MAC address data detected before matching for Bluetooth.

TABLE 15
monWiFiDataMatched
monWiFiDataMatched

pairedID
timestamp
wifiSync
wifiMAC
wifiDevice
wifiRSSI
wifiVendor
wifiMonLoc

Table 15: monWiFiDataMatched logs of any matches moniroted sites find on the database for WiFi.

TABLE 16
monBTDataMatched
monBTDataMatched

pairedID
timestamp
btSync
btMAC
btName
btRSSI
btVendor
btCOD
btMonLoc

Table 16: monBTDataMatched logs of any matches monitored sites find on the database for Bluetooth.

TABLE 17
subjectMatch
subjectMatch

subjectID
subjectWiFiMAC
subjectBtMAC
timeStamp

Table 17: subjectMatch includes a number of times subject detected in monitored sites and data sites.

TABLE 18
subjectInfo
subjectInfo

| | |
|---|---|
| subjectID | subPhone1 |
| subFirstName | subPhone2 |
| subLastName | subPhone3 |
| subDOB | subPhone4 |
| subAddr1 | subPhone5 |
| subAddr2 | subPhone6 |
| subCity | subTxt1 |
| subState | subTxt2 |
| subZIP | subTxt3 |

Table 18: subjectInfo includes information obtained for owner of license vehicle.

TABLE 19
subjectLastSeen
subjectLastSeen

pairedID
timestamp
subjectID
locID
monID

Table 19: subjectLastSeen includes locations where subject was seen with a timestamp.

TABLE 20
criminalWatchList
criminalWatchList

subjectID
crimeType
dateCommitted
notifyIfDetected
status

Table 20: criminalWatchList includes a criminal watch list that is compared to subjects/individuals 142 to determine if they are a criminal and who to notify if found.

TABLE 21
subNotifyLog
subNotifyLog

timestamp
clientID
subjectID
subPhoneTexted
msgSent
msgStatus

Table 21: subNotifyLog includes notifications sent to the subject to discourage crime.

TABLE 22
subNotifyReplyLog
subNotifyReplyLog

timestamp
clientID
subjectID
subPhoneTexted
msgReceived

Table 22: subNotifyReplyLog includes any replies from the subject after notification.

TABLE 23
clientNotifyLog
clientNotifyLog

timestamp
clientID
msgSent
msgStatus
msgType
numSent
emailSent

Table 23: clientNotifyLog includes log of notification attempts to the client (e.g., computing device 102 of a user).

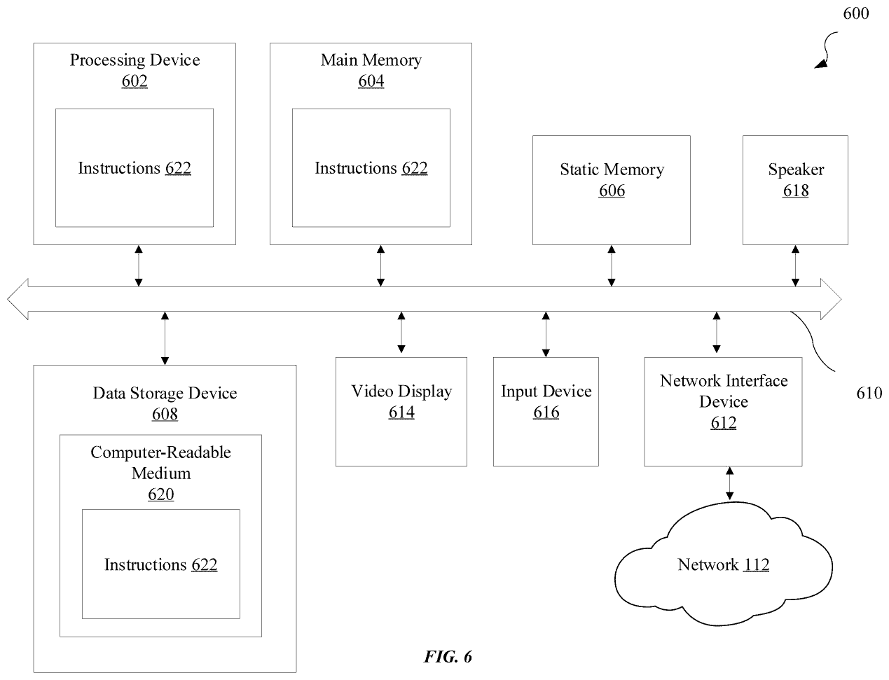

FIG. 6 illustrates example computer system 600 which can perform any one or more of the methods described herein, in accordance with one or more aspects of the present disclosure. In one example, computer system 600 may correspond to the computing device 102, server 118 of the cloud-based computing system 116, the cameras 120, and/or the electronic device identification sensors 130 of FIG. 1A. The computer system 600 may be capable of executing client application 104 of FIG. 1A. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a wearable (e.g., wristband), a set-top box (STB), a personal Digital Assistant (PDA), a mobile phone, a camera, a video camera, an electronic device identification sensor, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 600 includes a processing device 602, a main memory 604 (e.g., read-only memory (ROM), flash memory, dynamic random access memory (DRAM) such as synchronous DRAM (SDRAM)), a static memory 606 (e.g., solid state drive (SSD), flash memory, static random access memory (SRAM)), and a data storage device 608, which communicate with each other via a bus 610.

Processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions for performing any of the operations and steps discussed herein.

The computer system 600 may further include a network interface device 612. The computer system 600 also may include a video display 614 (e.g., a liquid crystal display (LCD) or a cathode ray tube (CRT)), one or more input devices 616 (e.g., a keyboard and/or a mouse), and one or more speakers 618 (e.g., a speaker). In one illustrative example, the video display 614 and the input device(s) 616 may be combined into a single component or device (e.g., an LCD touch screen).

The data storage device 616 may include a computer-readable medium 620 on which the instructions 622 (e.g., implementing control system, user portal, clinical portal, and/or any functions performed by any device and/or component depicted in the FIGURES and described herein) embodying any one or more of the methodologies or functions described herein is stored. The instructions 622 may also reside, completely or at least partially, within the main memory 604 and/or within the processing device 602 during execution thereof by the computer system 600. As such, the main memory 604 and the processing device 602 also constitute computer-readable media. The instructions 622 may further be transmitted or received over a network via the network interface device 612.

While the computer-readable storage medium 620 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The present disclosure additionally relates to techniques for generating personalized sales plans based on real-time customer activity. In particular, and according to some embodiments, the techniques include a method for managing proximity-activated customer retail offers (PACROs) for prospective customers of retail stores. The method can be implemented by at least one computing device, and includes the steps of (1) detecting that a prospective customer has satisfied a threshold likelihood of visiting a retail store; (2) obtaining first information associated with the prospective customer; (3) obtaining second information related to offerings associated with the retail store; (4) generating, based on the first and second information, a PACRO for the prospective customer; (5) identifying at least one mechanism through which the prospective customer can be engaged in a manner consistent with the PACRO; and (6) using the at least one mechanism and the PACRO, enabling at least one engagement with the prospective customer.

According to some embodiments, detecting that the prospective customer has satisfied the threshold likelihood of visiting the retail store comprises: (1) identifying that a vehicle associated with the prospective customer has entered a first geofence associated with the retail store; (2) identifying that the prospective customer has entered a second geofence associated with the retail store; (3) identifying that the prospective customer has engaged in at least one activity that suggests the prospective customer may intend to visit the retail store; or (4) some combination thereof.

According to some embodiments, the vehicle is identified using optical character recognition techniques to identify a license plate of the vehicle. According to some embodiments, the prospective customer is identified using eye, facial, voice, finger, gait, etc., biometric recognition techniques (or some combination thereof), and/or techniques for detecting computing devices associated with the prospective customer. According to some embodiments, the threshold likelihood of the prospective customer entering the retail store is satisfied based on: (1) the prospective customer selecting, on a website or a mobile application associated with the retail store, one or more options to: (i) view hours and/or location information associated with the retail store, (ii) view inventory information associated with the retail store, or (iii) some combination thereof; (2) the prospective customer contacting customer service associated with the retail store; (3) the prospective customer making at least one website, social media or other mobile-based post that mentions at least one of the offerings, the retail store, an entity that owns the retail store, or some combination thereof; or (4) some combination thereof.

According to some embodiments, the first information associated with the prospective customer comprises: (1) background check information, geographical information, educational information, employment history information, social network activity information, or some combination thereof; (2) products and/or services in which the prospective customer has satisfied a threshold level of interest; or (3) some combination thereof.

According to some embodiments, the second information related to offerings associated with the retail store comprises: (1) available products and/or services, if any, that are purchasable through the retail store, and that satisfy a similarity threshold when compared to the products, services, or some combination thereof, in which the prospective customer has satisfied the threshold level of interest; (2) extant promotions associated with the offerings; (3) dynamically-generated promotions; or (4) some combination thereof.

According to some embodiments, the at least one mechanism (through which the prospective customer can be engaged in a manner consistent with the PACRO) comprises: (1) at least one computing device operated by at least one employee of the retail store; (2) at least one human-computer interface (HCI) (including, e.g., a mobile application or website) associated with the retail store; or (3) some combination thereof. According to some embodiments, the at least one employee is identified based on: (1) satisfying a demographic or psychographic similarity threshold when compared to the prospective customer; (2) satisfying one or more knowledge thresholds about at least one offering on which the PACRO is based; or (3) some combination thereof.

According to some embodiments, the method can further include, prior to enabling the at least one engagement with the prospective customer using the at least one employee: (1) gathering information associated with the at least one employee; and (2) based on the information associated with the at least one employee, customizing the PACRO. According to some embodiments, customizing the PACRO comprises: (1) selecting one or more formats for content included in the PACRO; (2) including, in the PACRO: (i) motivational language that is likely to be effective in motivating the at least one employee, (ii) at least one compensation incentive based on the information associated with the at least one employee and/or the PACRO, (iii) dynamic routing instructions based on respective locations of the prospective customer and the at least one employee, or (iv) some combination thereof; (3) assigning a priority to the PACRO based on other PACROS, if any, that the at least one employee is currently servicing; or (4) some combination thereof. According to some embodiments, the PACRO can comprise audio content; video content; document content; haptic content; other multimedia or biometric content; or some combination thereof.

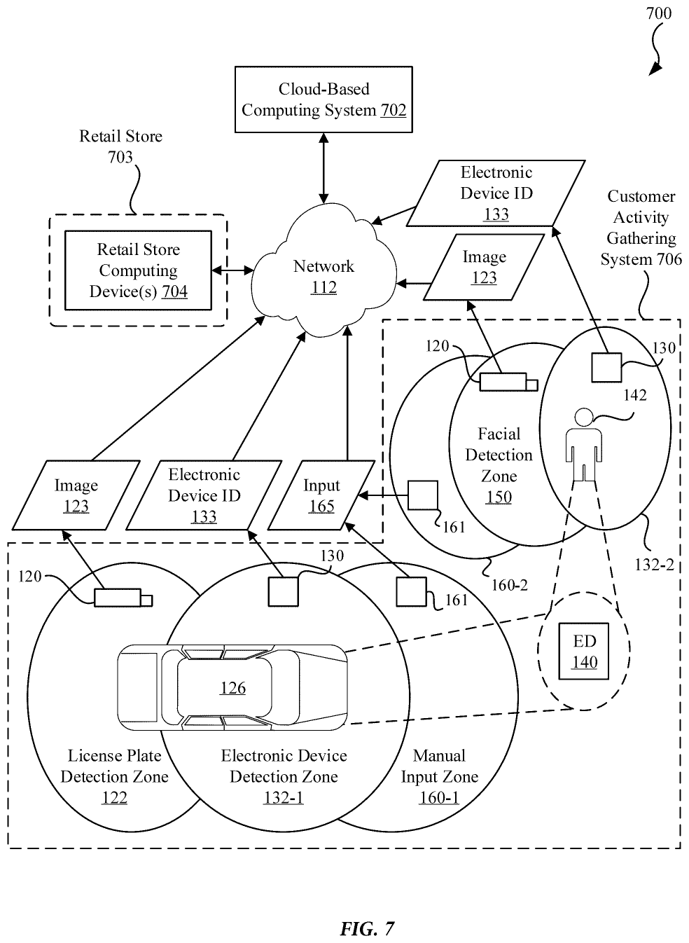

FIGS. 7 through 10, discussed below, and the various embodiments used to describe the principles of this disclosure are by way of illustration only and should not be construed in any way to limit the scope of the disclosure. As a brief aside, it is noted that, in the interest of simplifying this disclosure, the various entities illustrated in FIGS. 7 through 10 and described herein are often discussed in singular capacities. In that regard, it should be appreciated that one or more of the aforementioned entities can be singular or plural in nature, consistent with the scope of this disclosure.

FIG. 7 illustrates a high-level component diagram of an illustrative system architecture 700 that can be utilized to generate personalized sales plans based on real-time customer activity, as well as generate customized offerings for prospective customers of retail stores, according to certain embodiments of this disclosure. As shown in FIG. 7, the system architecture 700 can be designed in a manner similar to the system architecture 100 of FIG. 1 and can include a cloud-based computing system 702, as well as retail store computing devices 704 associated with a retail store 703. Additionally, the various detection/input zones previously described herein—as well as their associated elements—can constitute entities of which a customer activity gathering system 706 is comprised. According to some embodiments, the customer activity gathering system 706 can be utilized to identify information prospective customers of the retail stores 703. In turn, proximity-activated customer retail offers (PACROS) can be generated and provided to the retail store 703, wherein the details of such PACROs are described in greater detail herein.

According to some embodiments, the customer activity gathering system 706 can be associated with one or more retail stores 703 (e.g., brick-and-mortar stores, vendor stations, etc.) that are proximate to the customer activity gathering system 706. For example, the license plate detection zone 122 can cover a parking lot, a parking structure, etc., proximate to a retail store 703, the electronic device detection zone 132 can cover a sidewalk, a storefront area, etc., proximate to the retail store 703, the manual input zone 160 can represent exterior/interior areas of the retail store 703, and so on. Again, the foregoing examples are not meant to be limiting; the various zones can cover any area that the retail store 703 desires to monitor, and the various zones can overlap one another to any degree, consistent with the scope of this disclosure.

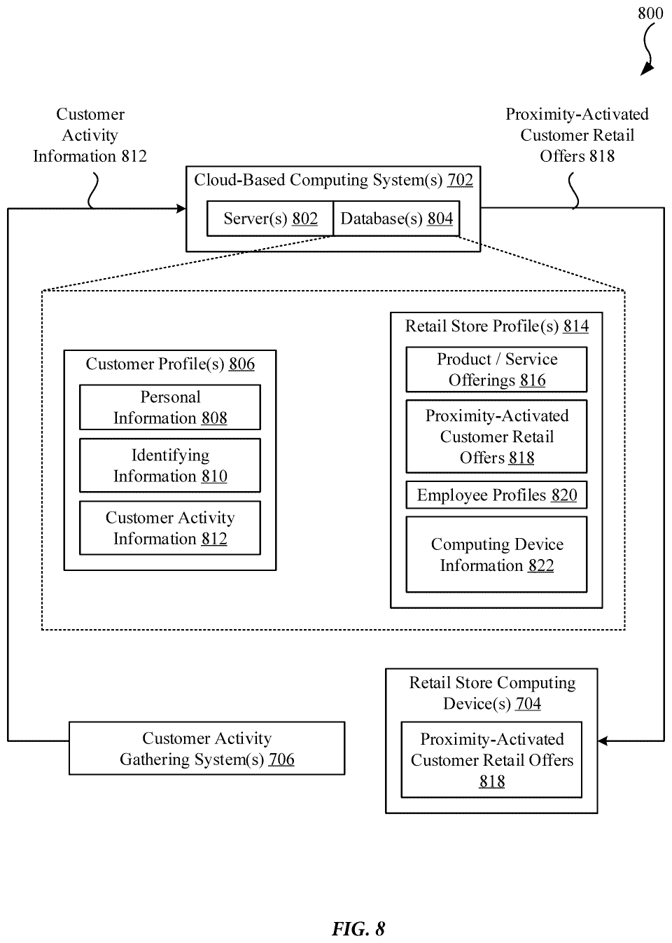

FIG. 8 illustrates a conceptual diagram 800 of details of the cloud-based computing system 702, the retail store computing device 704, and the customer activity gathering system 706, according to certain embodiments of this disclosure. As shown in FIG. 8, the cloud-based computing system 702 can include a server 802 and a database 804. According to some embodiments, the server 802 can be configured to implement any of the techniques disclosed herein, particularly those relating to managing proximity-activated customer retail offers (PACROs) for prospective customers of retail stores 703. As shown in FIG. 8, and according to some embodiments, the database 804 can store customer profiles 806, retail store profiles 814, and any other information relevant to implementing the techniques described herein.

According to some embodiments, a customer profile 806 can be maintained for each unique person known to the cloud-based computing system 702. As shown in FIG. 8, each customer profile 806 can include personal information 808, identifying information 810, and customer activity information 812. According to some embodiments, the personal information 808 for a given person can include, for example, the person's name, certain of the person's demographic information (e.g., background check information, geographical information, educational information, employment history information, social network activity information, etc.), certain of the person's psychographic information and the like. The foregoing examples are not meant to be limiting, and the personal information 808 can include any amount, type, form, etc., of personal information, at any level of granularity, consistent with the scope of this disclosure.

According to some embodiments, the identifying information 810 can include any information that enables the person to be identified, such as information about vehicles associated with the person (e.g., vehicle description, license plate info, etc.), biometric information (e.g., eye, facial, voice, finger, gait, etc.) associated with the person, information about electronic devices utilized by the person (e.g., laptops, tablets, smartphones, wearables, etc.), user accounts associated with the person, and so on. The foregoing examples are not meant to be limiting, and the identifying information 810 can include any amount, type, form, etc., of identifying information, at any level of granularity, consistent with the scope of this disclosure.

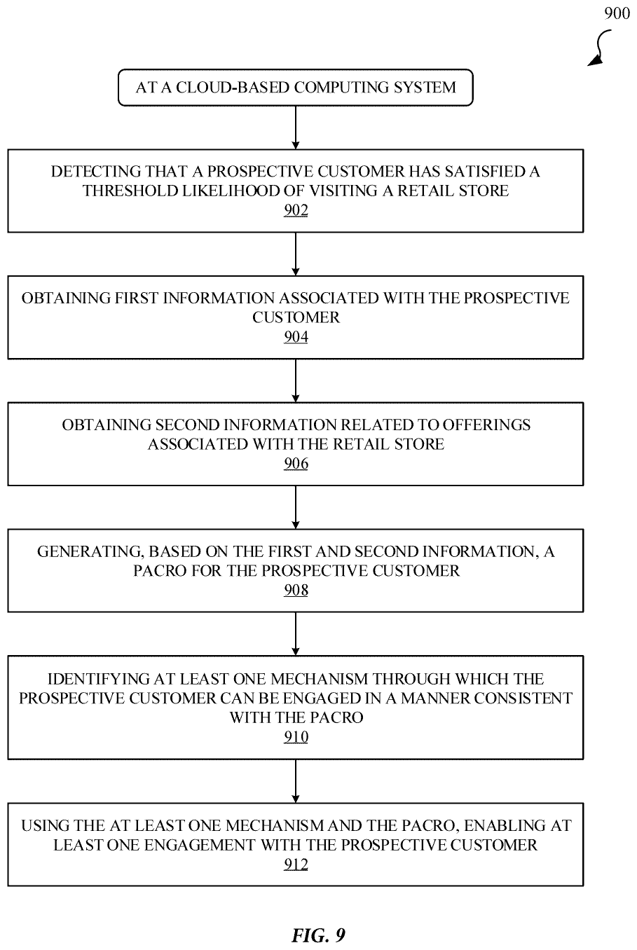

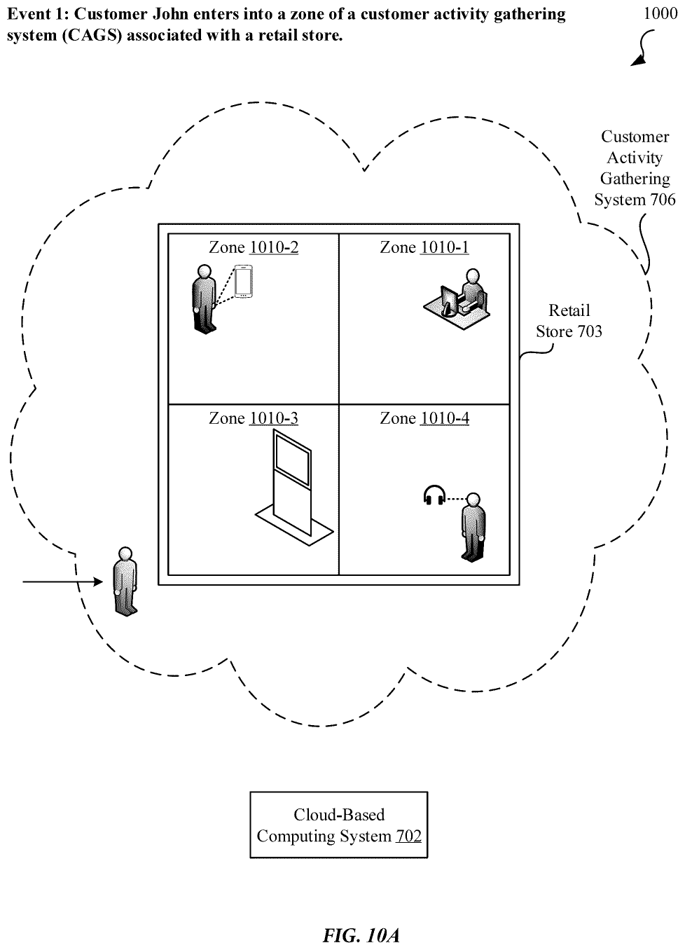

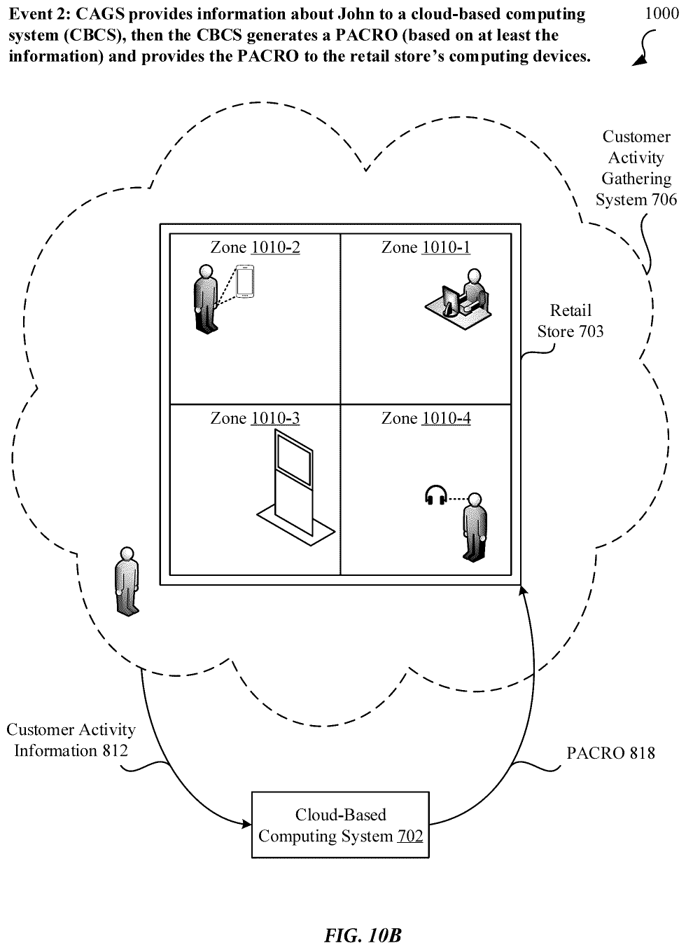

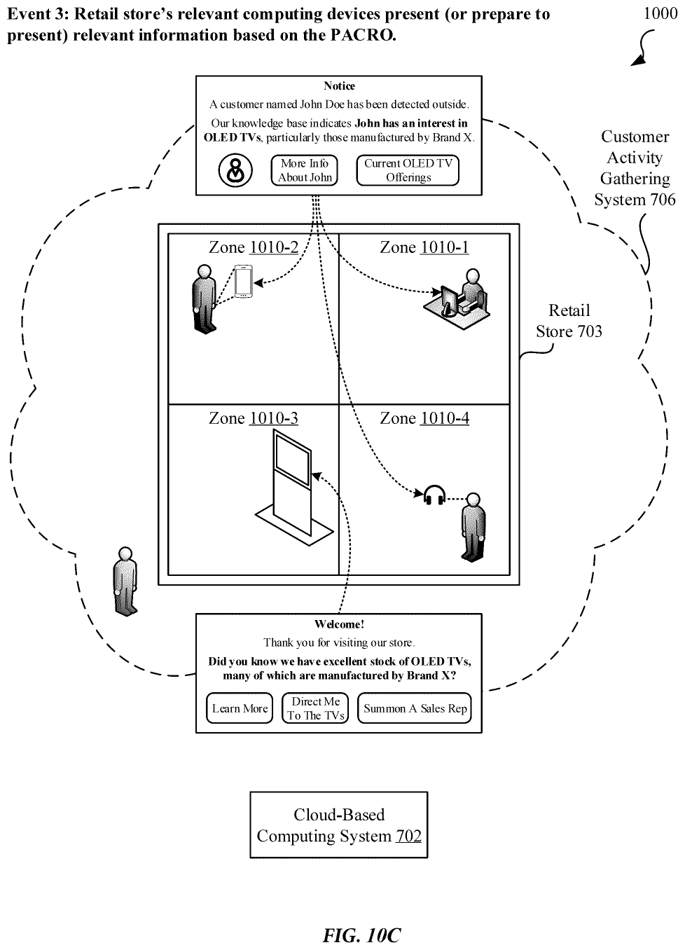

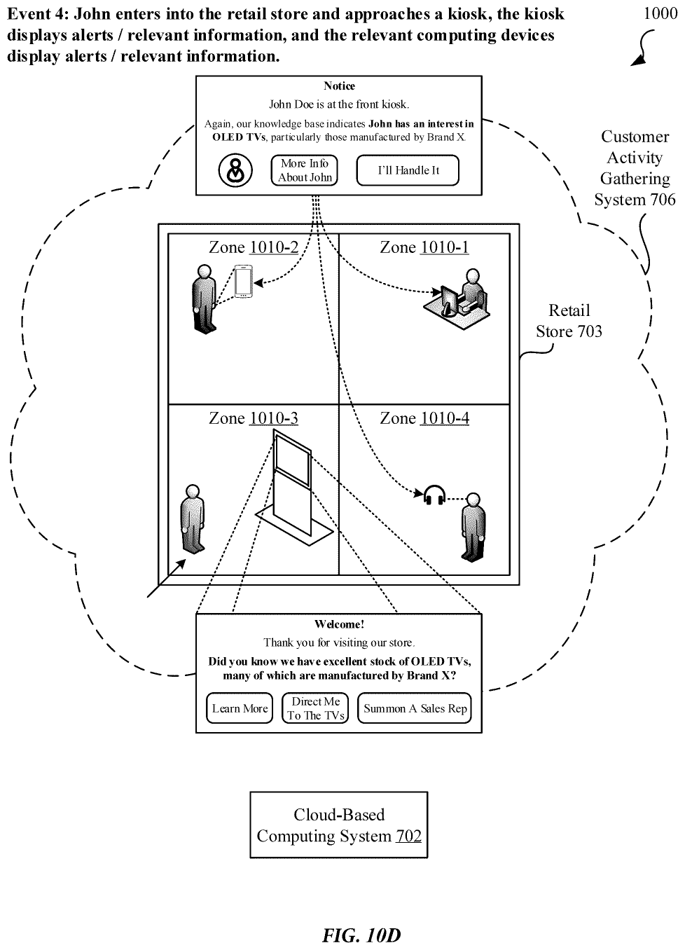

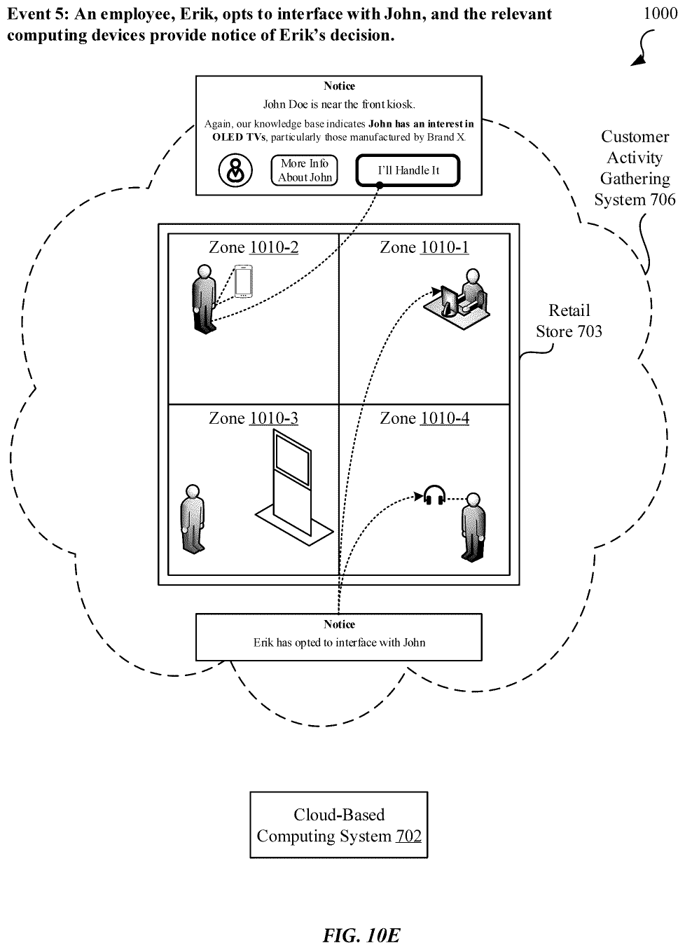

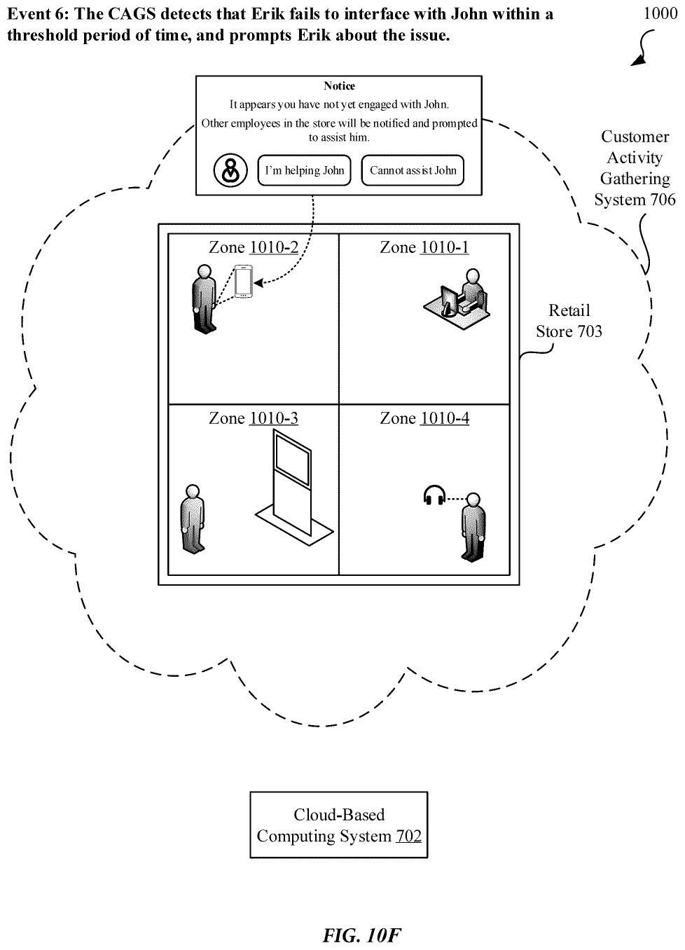

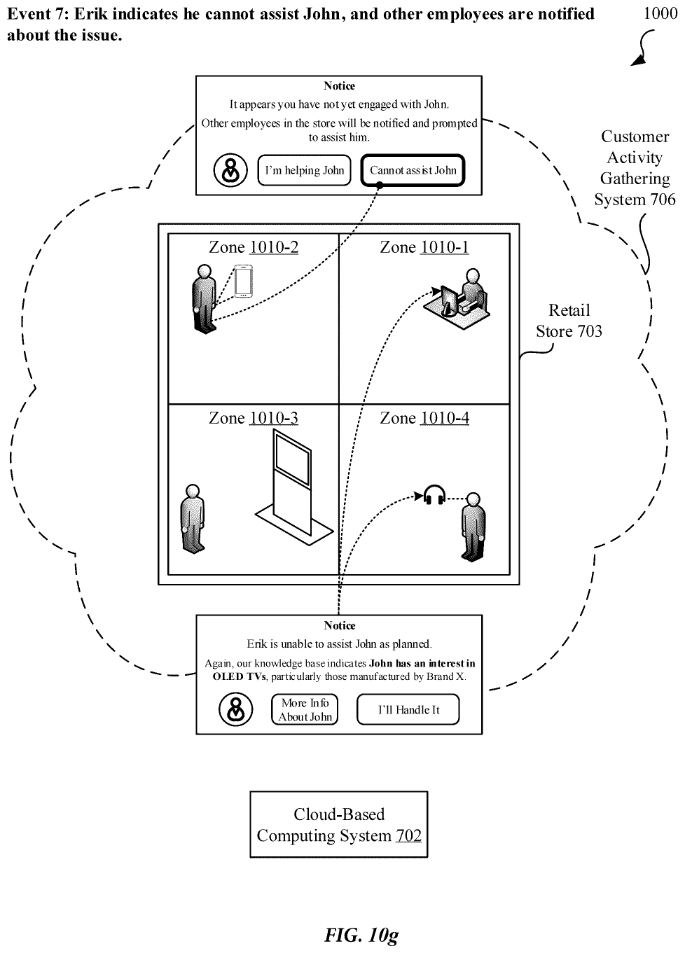

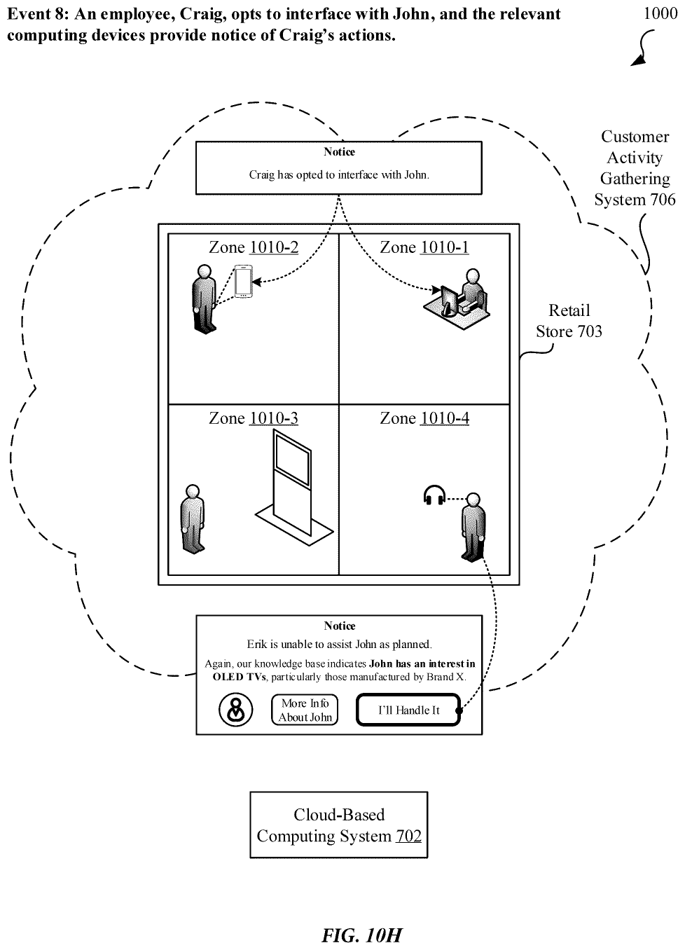

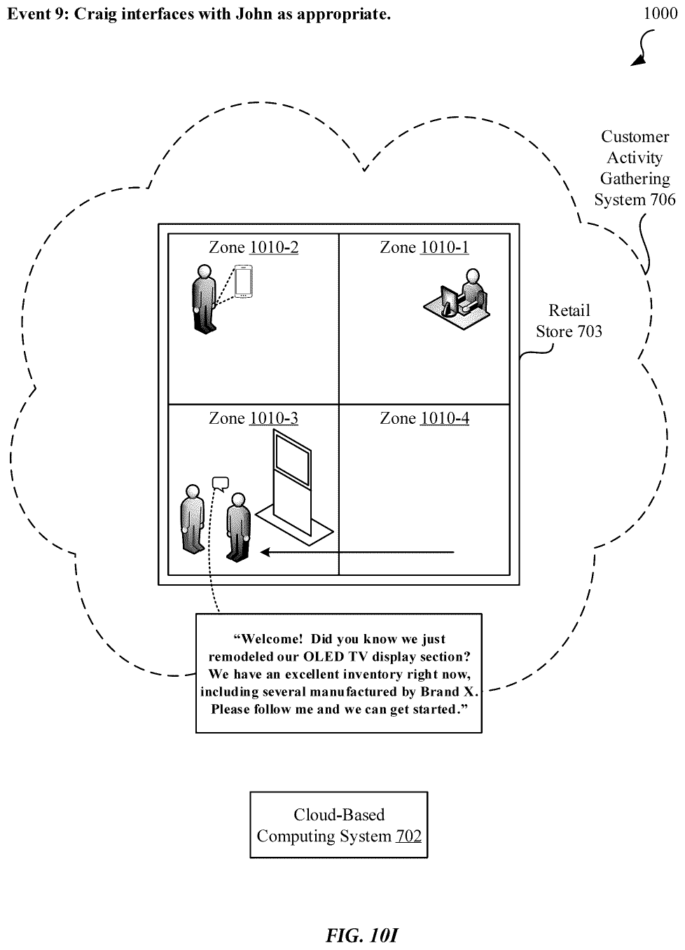

According to some embodiments, the customer activity information 812 can be provided by customer activity gathering systems 706, and it can include any information that is gathered through (or derived from information gathered through) the customer activity gathering system 706, and that is deemed, e.g., by the cloud-based computing system 702, to correspond to the person. For example, the customer activity information 812 can comprise historical location information, purchase activity information, web activity information, and so on. A more detailed explanation of how the customer activity information 812 can be gathered and matched to customer profiles 806 is provided below in conjunction with FIGS. 9-10. The foregoing examples are not meant to be limiting, and that the customer activity information 812 can include any amount, type, form, etc., of customer activity information, at any level of granularity, consistent with the scope of this disclosure.

As also shown in FIG. 8, a retail store profile 814 can be maintained for each unique retail store 703 known to the cloud-based computing system 702. According to some embodiments, each retail store profile 814 can include product/service offerings 816, proximity-activated customer retail offers (PACROs) 818, employee profiles 820, and computing device information 822. Although not illustrated in FIG. 8, it should be appreciated that each retail store profile 814 can also include identifying information associated with the retail store 703, such as the store's name, location, store hours, and so on. According to some embodiments, the product/service offerings 816 can include any information about extant products, services, etc., that are currently available through the retail store 703. In this regard, the information about the products, services, etc., can be gathered from a point-of-sale (POS) system utilized by the retail store 703, one or more websites associated with the retail store 703, one or more publications associated with the retail store 703, and so on. Additionally, and as described in greater detail below in conjunction with FIGURE X, the product/service offerings 816 can represent dynamically-generated (i.e., custom) offerings that are dynamically generated for prospective customers of retail stores 703. The foregoing examples are not meant to be limiting, and the product/service offerings 816 can include any amount, type, form, etc., of product/service offerings, at any level of granularity, consistent with the scope of this disclosure.

According to some embodiments, a given PACRO 818 can represent a customer-specific sales plan that can be provided to a retail store 703 when it is likely that the customer will approach, enter, etc., the retail store 703. In this regard, the PACRO 818 can include information derived from the customer profile 806, wherein the information corresponds to the customer; information derived from the product/service offerings 816; information derived from one or more employee profiles 820 of employees that will receive the PACRO 818 (e.g., via retail store computing devices 704), and/or any other information that is relevant. In any case, the PACRO 818 can be provided to one or more retail store computing devices 704 that can be configured to enable and/or execute an action in accordance with the PACRO 818. The foregoing examples are not meant to be limiting, and the PACRO 818 can include any amount, type, form, etc., of information, at any level of granularity, consistent with the scope of this disclosure. A more detailed explanation of how the PACROs 818 can be generated, utilized, and so on, is provided below in conjunction with FIGS. 9-10.

According to some embodiments, an employee profile 820 can be maintained for each employee that is employed by the retail store 703. Although not illustrated in FIG. 8, an employee profile 820 that corresponds to a given employee can include all or some of the information that is stored in the customer profiles 806 (i.e., personal information, identifying information, activity information), employment-specific information (e.g., job title, employment hours, job performance information, etc.), and so on. Additionally, and although not illustrated in FIG. 8, it should be appreciated that the retail store profile 814 can include management information that describes a hierarchy of responsibility, authority, approval levels or other distinction among the employees. The foregoing examples are not meant to be limiting, and the employee profile 820 can include any amount, type, form, etc., of employee information, at any level of granularity, consistent with the scope of this disclosure.

According to some embodiments, the computing device information 822 can include information about different computing devices, if any, that are located near, within, etc., the retail store 703, such as kiosks, POS systems, desktop computing devices, mobile computing devices, Internet of Things (IoT) devices, and so on. According to some embodiments, the computing device information 822 can include, for the aforementioned devices, hardware information (e.g., display capabilities, audio capabilities, input capabilities, etc.), software information (e.g., client applications installed on the devices, PACRO 818 formats that can be interpreted by the devices, etc.), location information (e.g., where the devices are positioned within the retail store 703), and so on. The foregoing examples are not meant to be limiting, and the computing device information 822 can include any amount, type, form, etc., of information, at any level of granularity, consistent with the scope of this disclosure.

Accordingly, the conceptual diagram 800 of FIG. 8 provides an overview of the manner in which the cloud-based computing system 702, the retail store computing device 704, and the customer activity gathering system 706 can interoperate with one another.

FIG. 9 illustrates a method 900 for managing proximity-activated customer retail offers (PACROs) 818 for prospective customers of retail stores 703, according to certain embodiments of this disclosure. As shown in FIG. 9, the method 900 begins at step 902, where the cloud-based computing system 702 detects that a prospective customer has satisfied a threshold likelihood of visiting a retail store 703.

To implement step 902, the cloud-based computing system 702 can be configured to receive, as input, customer activity information 812 from a customer activity gathering system 706. In turn, the cloud-based computing system 702 can identify a customer profile 806, if any, of an individual that corresponds to the customer activity information 812. In particular, the cloud-based computing system 702 can be configured to compare the customer activity information 812 with the personal information 808, the identifying information 810, the customer activity information 812, etc., of customer profiles 806 for the purpose of identifying a customer profile 806, if any, that satisfies similarity thresholds enforced by the cloud-based computing system 702. In this regard, the similarity thresholds can be adjusted, as appropriate, to reduce false negative and false positive identifications. The customer activity information 812 of the customer profile 806 can also be updated to reflect the customer activity information 812 received from the customer activity gathering system 706. Again, although the embodiments discuss identifying a single customer profile 806 based on customer activity information 812, the embodiments can also support identifying two or more customer profiles 806 based on the customer activity information 812 (e.g., when the aforementioned similarity thresholds are satisfied by two or more customer profiles 806).

When the cloud-based computing system 702 is unable to identify a customer profile 806 based on the customer activity information 812—i.e., when the prospective customer associated with the customer activity information 812 is unknown to the cloud-based computing system 702—the cloud-based computing system 702 can generate a new customer profile 806 for the prospective customer. In turn, the cloud-based computing system 702 can populate the personal information 808, the identifying information 810, and the customer activity information 812. For example, the cloud-based computing system 702 can reference the customer activity information 812 against public/private information sources to gather and/or receive information relevant to the personal information 808, the identifying information 810, and/or the customer activity information 812. In turn, the cloud-based computing system 702 can filter, supplement, etc., the gathered information, and then store it as the personal information 808, the identifying information 810, and/or the customer activity information 812, where appropriate.

To implement the aforementioned features, the cloud-based computing system 702 can employ one or more artificial intelligence (AI) models that have been trained to receive customer activity information 812 as input and provide customer profiles 806 as output. However, non-AI-based approaches can be utilized to implement the same or similar functionalities as the AI-based approaches described herein. All or some of the aforementioned features can be implemented by the customer activity gathering system 706, consistent with the scope of this disclosure. For example, the customer activity gathering system 706 can be configured to identify individuals based on the heavy-duty information (e.g., audio data, video data, motion data, etc.) it collects, and then provide lightweight information—such as an identifier, a name, etc.—about the individuals to the cloud-based computing system 702. In turn, the cloud-based computing system 702 can identify (or generate) customer profiles 806 based on the lightweight information, without the need to receive/process the heavy-duty information. In this manner, bandwidth utilization and processing overhead can be substantially reduced.

Accordingly, at the conclusion of step 902, the cloud-based computing system 702 will have identified a customer profile 806 of the prospective customer to which the customer activity information 812 corresponds. Next, the cloud-based computing system 702 is tasked with determining whether the prospective customer satisfies a threshold likelihood of visiting a retail store 703 (e.g., that is known to the cloud-based computing system 702). The cloud-based computing system 702 can perform any number of steps to make this determination. In one example, when the prospective customer has not yet entered a retail store 703, the cloud-based computing system 702 can identify, based on the prospective customer's current location and locations of retail stores 703 (included in retail store profiles 814), one or more retail stores 703, if any, to which the prospective customer is proximate (e.g., within a particular threshold distance). In turn, the cloud-based computing system 702 can track the prospective customer's movements to identify whether the prospective customer is heading toward (or could head toward, due to their proximity) any of the retail stores 703, which can help identify a particular retail store 703 (among the aforementioned retail stores 703) that should potentially be notified. Alternatively, the cloud-based computing system 702 can identify when the prospective customer has entered a retail store 703, e.g., when the prospective customer enters through a door of the retail store 703, is located within a geofence of the retail store 703, and so on.

The cloud-based computing system 702 can be configured to identify when prospective customers approach and/or enter retail stores 703 that are not registered with the cloud-based computing system 702. In turn, such identifications can be utilized to demonstrate sales opportunities that potentially were missed. Consider, for example, a scenario in which the cloud-based computing system 702 identifies that a prospective customer who is interested in a tennis racquet (based on, for example, web activity indicating the prospective customer's need/desire to purchase a tennis racquet), enters into a sporting goods store (that is not registered with the cloud-based computing system 702), and then exits shortly thereafter without a tennis racquet. When this scenario occurs, the cloud-based computing system 702 can generate a report that includes information about the prospective customer (e.g., based on information derived from the customer profile 806), information about the prospective customer's interaction with the sporting goods store (e.g., entering on a particular date/time, then leaving minutes later with no purchased items), and information about relevant PACRO services that can be offered to the sporting goods store. The report can then be provided to a managing entity of the retail store 703 so that the managing entity can be made aware of missed sales opportunities and potentially mitigate them by accessing the PACRO services provided by the cloud-based computing system 702.

Additionally, the cloud-based computing system 702 can be configured to take relationships into account when identifying prospective customers. Consider, for example, a scenario where a prospective customer, Jane, has repeatedly browsed a hats section of website of a retail store 703 that provides fitness apparel. Consider, further, that Jane's husband, Mark, ends up visiting the retail store 703. In this scenario, the cloud-based computing system 702 can (1) detect Mark's presence at the retail store 703, (2) detect that Mark has not shown any interest in the retail store 703, its products/services, etc., and (3) detect that Mark is married to Jane, who has shown the aforementioned interest. In turn, the cloud-based computing system 702 can obtain information for Mark that is based on Jane's customer profile 806 (e.g., in accordance with the techniques described below in conjunction with step 904 of FIG. 9 and in a privacy-respectful manner). In this manner, when Mark approaches, enters into, etc., the retail store 703, appropriate measures can be taken to effectively assist Mark (consistent with the techniques disclosed herein) in shopping on behalf of Jane. The foregoing examples are not meant to be limiting, and any type, form, etc., of relationship(s) between individuals, at any degree of separation, can be assessed, consistent with the scope of this disclosure.

Accordingly, at the conclusion of step 902, the cloud-based computing system 702 detects that a prospective customer has satisfied a threshold likelihood of visiting a retail store 703 that is known to the cloud-based computing system 702. In turn, at step 904, the cloud-based computing system 702 obtains first information associated with the prospective customer. The first information can include, for example, any information stored in the customer profile 806 associated with the prospective customer. The first information can also include, for example, updated customer activity information 812 that is gathered as the prospective customer remains proximate to the retail store 703, such as movement information (e.g., indicating the customer has entered the retail store 703), web, social media or mobile device activity information (e.g., an online post indicating the customer plans on visiting the retail store shortly), and so on.

Additionally, the first information can include information about companions detected with the prospective customer, such as spouses, children, siblings, significant others, friends, and so on. This information can be utilized to provide a variety of useful features. For example, when the cloud-based computing system 702 detects that the prospective customer is accompanied by at least one child, the PACRO 818 (generated in conjunction with step 908 described below) can indicate that inventory in which the prospective customer is interested should be brought to the area of the retail store 703 that the prospective customer is most likely to enter or pass through (so as to provide a seamless shopping experience to the presumably busy parent). Additionally, PACROs 818 can be generated for the detected companions, so that both the prospective customer and the companions can be approached in an optimal manner (using the PACROs 818 in accordance with the techniques described herein).

The foregoing examples are not meant to be limiting, and the first information can include any amount, type, form, etc., of information about the prospective customer, at any level of granularity, consistent with the scope of this disclosure. At step 906, the cloud-based computing system 702 obtains second information related to offerings associated with the retail store. The second information can include, for example, any information stored in the retail store profile 814 of the retail store 703, such as product/service offerings 816 that describe available products and/or services, if any, that are purchasable through the retail store 703, extant promotions associated with the offerings, dynamically-generated promotions, and so on.

According to some embodiments, to increase the overall efficiency by which the second information is gathered, generated, etc., and also to decrease the overall size of the second information, thereby improving overall efficiency, the first information can function as a filter when obtaining the second information. In particular, given that the first information indicates products/services in which the prospective customer may be interested, one or more search terms can be derived, deduced, inferred or copied (hereinafter, collectively “derivation”) from the first information and utilized to obtain the second information. The aforementioned derivation can be performed using a variety of approaches, such as through the implementation of an Al model (e.g., a large language model (LLM) that is trained to receive the first information as an input and to provide search terms as an output). For example, if the first information indicates, e.g., by way of the customer activity information 812, that the prospective customer actively plays pickleball, then the search terms can include pickleball racquets, pickleballs, pickleball apparel, pickleball bags, pickleball lessons, and so on. In turn, when the search terms are applied against the product/service offerings 816, the second information can include all product/service offerings 816 that match the search terms (or some subset thereof). The foregoing examples are not meant to be limiting, and the second information can be obtained, generated, etc., based on any amount, type, form, etc., of information, at any level of granularity and using any technological approach (AI-based, non-AI based, etc.), consistent with the scope of this disclosure.

At step 908, the cloud-based computing system 702 generates, based on the first and second information, a proximity-activated customer retail offer (PACRO 818) for the prospective customer. As described above, the first information can include information associated with the customer profile 806 of the prospective customer, and the second information can include information associated with product/service offerings 816 of the retail store 703 where such product/service offerings are relevant to the prospective customer. In this regard, step 908 involves the cloud-based computing system 702 generating a PACRO 818 that includes information about the prospective customer as well as information about the relevant product/service offerings 816.

According to some embodiments, the PACRO 818 can include the name of the prospective customer, a picture of the prospective customer, a description of the prospective customer's appearance, customer activity information 812 associated with the prospective customer (e.g., a number of times the prospective customer has visited the retail store 703, web activity performed by the prospective customer and associated with the retail store 703, etc.), and so on. According to some embodiments, the aforementioned information can be selected, formatted, etc., in accordance with a template that corresponds to the prospective customer, the retail store 703, the product/service offerings 816 indicated in the second information, and the like. The foregoing examples are not meant to be limiting, and the PACRO 818 can include any amount, type, form, etc., of information derived from the first information (or elsewhere, when/where appropriate), at any level of granularity, consistent with the scope of this disclosure.

According to some embodiments, the PACRO 818 can include the names of the product/service offerings 816 indicated in the second information, details associated with the product/service offerings 816 (e.g., hyperlinks to webpages associated with the product/service offerings 816, availability of the product/service offerings 816, etc.), and so on. According to some embodiments, the aforementioned information can be selected, formatted, etc., in accordance with a template that corresponds to the prospective customer, the retail store 703, the product/service offerings 816, and the like. The foregoing examples are not meant to be limiting, and the PACRO 818 can include any amount, type, form, etc., of information derived from the second information (or elsewhere, when/where appropriate), at any level of granularity, consistent with the scope of this disclosure.

According to some embodiments, the aforementioned information included in the PACRO 818 can be expanded on, formatted, etc., so that the information can be presented on retail store computing devices 704 in a readable manner, an optimal manner, etc. For example, the image-based information about the prospective customer can include a registered picture of the prospective customer, as well as pictures, videos, etc., captured of the prospective customer when the prospective customer is in proximity to the retail store 703. In this manner, employees of the store can review up-to-date appearance information that will enable the employees to easily identify the prospective customer. In another example, the text-based information about the prospective customer can be incorporated into descriptive sentences, e.g., “Customer X is about to enter the store. She is wearing a green shirt and is pushing a stroller.” In another example, the information about the product/service offerings 816 can include videos, images, etc., of the product/service offerings 816. In this manner, employees of the store can refresh their understanding of the product/service offerings 816, if necessary, prior to engaging with the prospective customer, human-computer interfaces (HCI) (e.g., kiosks, terminals, etc.) of the store can display the information in a manner that enables the prospective customer to interact with the HCIs, and so on. In another example, the text-based information about the product/service offerings 816 can be incorporated into descriptive sentences, e.g., “Our knowledge base indicates Customer X has an interest in purchasing children's pool toys.” The foregoing examples are not meant to be limiting, and the PACRO 818 can include any amount, type, form, etc., of information, at any level of granularity, consistent with the scope of this disclosure.

At step 910, the cloud-based computing system 702 identifies at least one mechanism through which the prospective customer can be engaged in a manner consistent with the PACRO 818. According to some embodiments, the cloud-based computing system 702 identifies, based on any information included in the retail store profile 814 (and/or other information, when/where appropriate), how the PACRO 818 should be enabled or presented, the format(s) in which the PACRO 818 should be enabled or presented, and so on. According to some embodiments, the cloud-based computing system 702 can identify, based on employee profiles 820, the computing device information 822, etc., the employees on duty at the time the prospective customer is visiting the store, the retail store computing devices 704 being utilized by the employees, and so on. The cloud-based computing system 702 can also identify, based on the type of retail store computing devices 704, how the PACRO 818 should be formatted/delivered to/displayed on the retail store computing devices 704.

In one example, when the PACRO 818 is provided to retail store computing devices 704 utilized by employees and equipped with display devices, input devices, etc., the PACRO 818 can include all information that enables software applications installed on the retail store computing devices 704 to enable the employees to interact with information included in, derived from, etc., the PACRO 818. In another example, when the PACRO 818 is provided to retail store computing devices 704 utilized by employees and equipped with audio devices—such as wireless radio systems connected to headsets worn by the employees—the PACRO 818 can include audio information that enables the employee to receive information included in, derived from, etc., the PACRO 818. In yet another example, when the PACRO 818 is provided to retail store computing devices 704 utilized by prospective customers—such as kiosks, terminals, etc.—the PACRO 818 can include all information that enables software applications installed on the aforementioned retail store computing devices 704 to enable customers to interact with the information included in, derived from, etc., the PACRO 818. In this example, the PACRO 818 can be displayed in a manner that, in order to reduce privacy concerns, removes the private information from view by the prospective customer.

Notably, the cloud-based computing system 702 can customize a PACRO 818 based on the employee set to receive the PACRO 818 (e.g., via a retail store computing device 704 operated by the employee). In particular, the cloud-based computing system 702 can obtain information about a given employee (via their employee profile 820) and identify optimizations that can be made to the PACRO 818 in order to improve the overall effectiveness of the techniques disclosed herein. Consider, for example, a scenario in which an employee of a retail store 703 is underperforming relative to sales expectations. In this example, the PACRO 818 can be customized to include motivational content, such as words of encouragement, recommended sales tactics, economic incentives (e.g., a special bonus for completing a sale), and so on. The foregoing examples are not meant to be limiting, and the PACRO 818 can be customized based on any amount, type, form, etc., of information, at any level of granularity, consistent with the scope of this disclosure.

At step 912, the cloud-based computing system 702, using the at least one mechanism and the PACRO 818, enables at least one engagement with the prospective customer. As discussed above, this step can involve the retail store computing devices 704 executing an action, as appropriate, in conjunction with receiving the PACRO 818. For example, when the retail store computing device 704 utilized by a given employee receives a respective PACRO 818, the retail store computing device 704 can provide an audible, haptic, etc., notification to alert the employee about the prospective customer. In another example, when the retail store computing devices 704 utilized by prospective customers (e.g., kiosks) receive the PACRO 818, the retail store computing devices 704 can perform configuration updates, initializations, etc., to enable the retail store computing devices 704 to engage with the prospective customer as appropriate. This can involve, for example, the retail store computing devices 704 updating configurations to actively search for the prospective customer, to output information (e.g., visually, audibly, etc.) included in the PACRO 818 when the prospective customer is within range of the retail store computing devices 704, and so on. According to some embodiments, the retail store computing devices 704 can be configured to implement respective queues of PACROs 818 so that the queues can be prioritized (automatically, by employee input, etc.) for handling. The foregoing examples are not meant to be limiting, and the retail store computing devices 704 can perform any amount, type, form, etc., of operations in response to receiving the PACRO 818, at any level of granularity, consistent with the scope of this disclosure.

Accordingly, FIG. 9 illustrates a method 900 for managing proximity-activated customer retail offers (PACROs) for prospective customers of retail stores 703, according to certain embodiments of this disclosure. Additionally, FIGS. 10A-10I illustrate conceptual diagrams 1000 that provide additional context about how the techniques described herein can be utilized, according to certain embodiments of this disclosure. In the example setup illustrated in FIG. 10A, a retail store 703 can be segmented into zones 1010-1, 1010-2, 1010-3, and 1010-4. A first employee, Sara, is located in the zone 1010-1, and is operating a first retail store computing device 704 (e.g., a desktop computer). A second employee, Erik, is located in the zone 1010-2, and is operating a second retail store computing device 704 (e.g., a mobile computing device). A third employee, Craig, is located in the zone 1010-4, and is operating a fourth retail store computing device 704 (e.g., a wireless radio system connected to a headset). Additionally, a third retail store computing device 704—e.g., a kiosk—is located in the zone 1010-3, and includes a display device, a speaker, and input controls. The aforementioned setup can be reflected in the retail store profile 814 associated with the retail store 703.

In the example illustrated in FIG. 10A, the retail store 703 is associated with a customer activity gathering system 706 capable of detecting prospective customers that are in proximity to the retail store 703, that have entered the retail store 703, and so on. As shown in FIG. 10A, a first event involves a prospective customer, John, being detected by the customer activity gathering system 706. As previously described herein, John can be identified by the customer activity gathering system 706, the cloud-based computing system 702 (e.g., using information provided by the customer activity gathering system 706), other computing devices/services, or some combination thereof (e.g., in accordance with the detection techniques described herein).

Turning now to FIG. 10B, a second event involves the customer activity gathering system 706 providing, to the cloud-based computing system 702, information about John (e.g., in the form of customer activity information 812). In turn, the cloud-based computing system 702 generates a PACRO 818 (e.g., in accordance with the PACRO 818 generation techniques described herein) and transmits the PACRO 818 to the four retail store computing devices 704. As shown in FIG. 10C, the relevant retail store computing devices 704 present—or prepare to present—information based on the PACRO 818.

In the example illustrated in FIG. 10C, the PACRO 818 that is delivered to the three retail store computing devices 704 of the employees indicates that John has been detected outside of the retail store 703, and that John has an interest in OLED TVs manufactured by Brand X. The PACRO also includes an image of John, additional information about John, and additional information about current OLED TV offerings available through the retail store 703. As shown in FIG. 10C, the aforementioned retail store computing devices 704 can output a notification that includes the aforementioned information, features, and so on. For example, the retail store computing devices 704 that have display devices can output user interfaces, and the retail store computing device 704 that is operated via a headset can output audio that explains the nature of the prospective customer potentially visiting the retail store 703. According to some embodiments, each retail store computing device 704 can be configured to present the notification in accordance with the then-current environment, such as whether the employee is busy with another prospective customer, whether the retail store computing device 704 is on the employee's person, whether the employee is already assigned a threshold number of PACROs 818 (e.g., using a queue) to address, and so on.

Additionally, in the example illustrated in FIG. 10C, the PACRO 818 that is delivered to the fourth retail store computing device 704 utilized by prospective customers—i.e., the kiosk—includes information about John, a welcome message, information about OLED TVs manufactured by Brand X that are available through the retail store 703, information about a navigational path through the store from the kiosk to the OLED TVs, and so on. In this regard, the kiosk can update a configuration to actively search for John's presence (e.g., using any of the recognition techniques described herein) so that the kiosk can display information when John is proximate to the kiosk—which, as shown in FIG. 10C, includes an option to summon a sales representative. Information can also be transmitted to the kiosk—e.g., from the customer activity gathering system 706—to effectively inform the kiosk when John is proximate to it. In turn, the kiosk can display the information without having to search for John.

Turning now to FIG. 10D, a fourth event involves detecting that John has entered the retail store 703, causing the kiosk to display relevant alerts/information, and causing the relevant retail store computing devices 704 of the employees to display relevant alerts/information. As shown in FIG. 10D, the information displayed on the relevant retail store computing devices 704 differs from what was originally displayed, in that it includes up-to-date location information about John (i.e., that John is at the front kiosk, rather than outside, where previously detected), and also includes an option to enable a given one of the employees to indicate that they will interface with John.

Turning now to FIG. 10E, a fifth event involves employee Erik opting to interface with John. In turn, the relevant retail store computing devices 704—i.e., those utilized by employees aside from John—can display a notification that indicates Erik has opted to interface with John. Turning now to FIG. 10F, a sixth event involves the customer activity gathering system 706 (and/or the cloud-based computing system 702, other computing devices/services, etc.) detecting that Erik has failed to interface with John within a threshold period of time (e.g., two minutes). For example, one or more of the aforementioned entities can detect that Erik never became proximate to John, that John is wandering around the store unaccompanied by any employees, that John selected the option at the kiosk to summon a sales representative (e.g., a threshold period of time after Erik opted to interface with John), and so on. In turn, a notification is displayed on Erik's retail store computing device 704, where the notification describes the nature of the issue, includes information about John, includes an option to indicate that Erik is in fact helping John, includes an option that Erik cannot help John as Erik had originally planned, and so on.

Turning now to FIG. 10G, a seventh event involves employee Erik indicating that he cannot assist John, which causes other employees to be notified (via their respective retail store computing devices 704) about the issue. As shown in FIG. 10G, the notification to the other employees describes the nature of the issue, includes information about John and his interests, includes an option to view more information about John, and includes an option to volunteer to assist John. The notification can include additional information, such as the amount of time that John has remained unattended, an assessment of John's mood (e.g., whether he appears to be getting impatient), and so on. Optimization metrics can also be employed, such as identifying the employee that is most proximate to John and incentivizing that employee to attend to John as soon as possible. Turning now to FIG. 10H, an eighth event involves employee Craig opting to interface with John. In turn, the relevant retail store computing devices 704—e.g., those operated by Erik and Sara—are notified of Craig volunteering to take action.

Turning now to FIG. 10I, a ninth event involves employee Craig interfacing with John as appropriate. As shown in FIG. 10I, Craig is guided by the information that is accessible via the retail store computing device 704 and the PACRO 818 provided thereto. In particular, Craig can greet John and immediately capture John's attention by mentioning OLED TVs, Brand X, and ample inventory.

The present disclosure additionally relates to techniques for generating customized offerings for prospective customers of retail stores. In particular, a method can be implemented by at least one computing device, and includes the steps of (1) obtaining first information associated with a prospective customer of a retail store, (2) obtaining second information related to extant offerings associated with the retail store, (3) generating, based on the first and second information, third information related to one or more customized offerings for the prospective customer, (4) generating, based on the first and third information, a proximity-activated customer retail offer (PACRO) for the prospective customer, (5) identifying at least one mechanism through which the prospective customer can be engaged in a manner consistent with the PACRO, and (6) using the at least one mechanism and the PACRO, enabling at least one engagement with the prospective customer. According to some embodiments, the PACRO is further generated based on the second information related to extant offerings associated with the retail store.

According to some embodiments, the method can further include the step of, prior to obtaining the first information: detecting that the prospective customer has satisfied a threshold likelihood of visiting the retail store. According to some embodiments, detecting that the prospective customer has satisfied the threshold likelihood of visiting the retail store comprises: (1) identifying that a vehicle associated with the prospective customer has entered a first geofence associated with the retail store; (2) identifying that the prospective customer has entered a second geofence associated with the retail store; (3) identifying that the prospective customer has engaged in at least one activity that suggests the prospective customer may intend to visit the retail store; or (4) some combination thereof.

According to some embodiments, the first information associated with the prospective customer comprises: (1) background check information, geographical information, educational information, employment history information, social network activity information, or some combination thereof; (2) products and/or services in which the prospective customer has satisfied a threshold level of interest; or (3) some combination thereof.

According to some embodiments, the second information related to extant offerings associated with the retail store comprises: available products and/or services, if any, that are purchasable through the retail store, and that satisfy a similarity threshold when compared to the products, services, or some combination thereof, in which the prospective customer has satisfied the threshold level of interest; or some combination thereof.

According to some embodiments, each customized offering of the one or more customized offerings is associated with a respective available product or service among the available products or services, and generating the customized offering comprises establishing, for the respective available product or service: a customized price, a customized financing option, a customized inventory count, a customized bundle option, a customized reward for exercising the customized offering, a customized available time limit for exercising the customized offering, or some combination thereof.

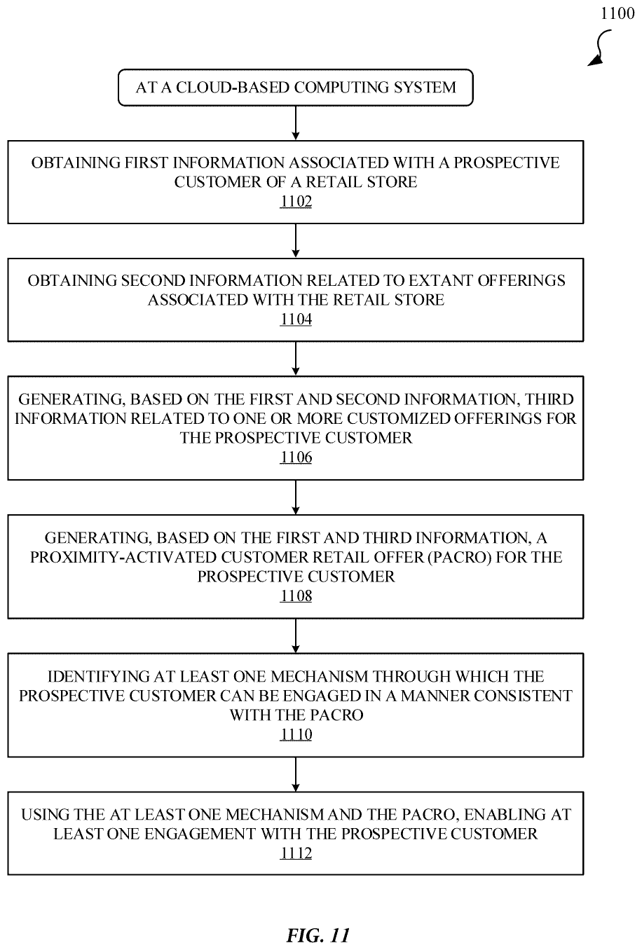

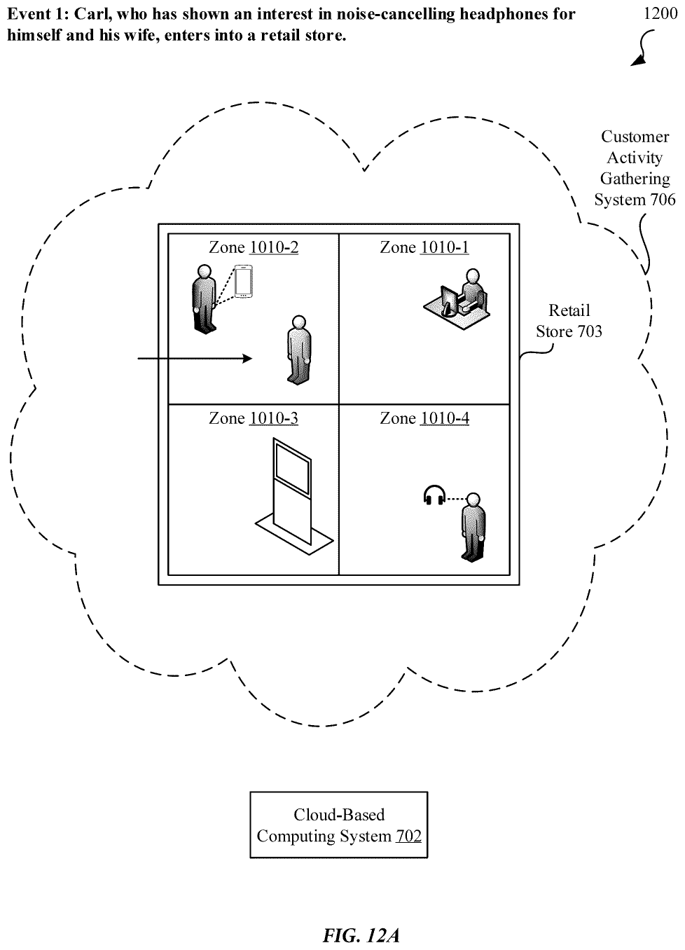

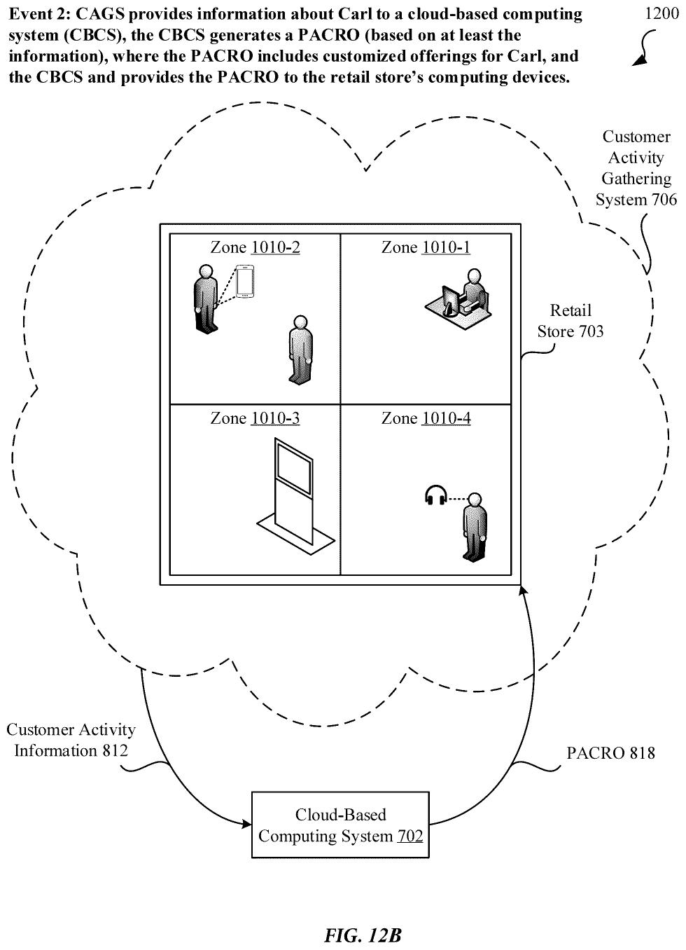

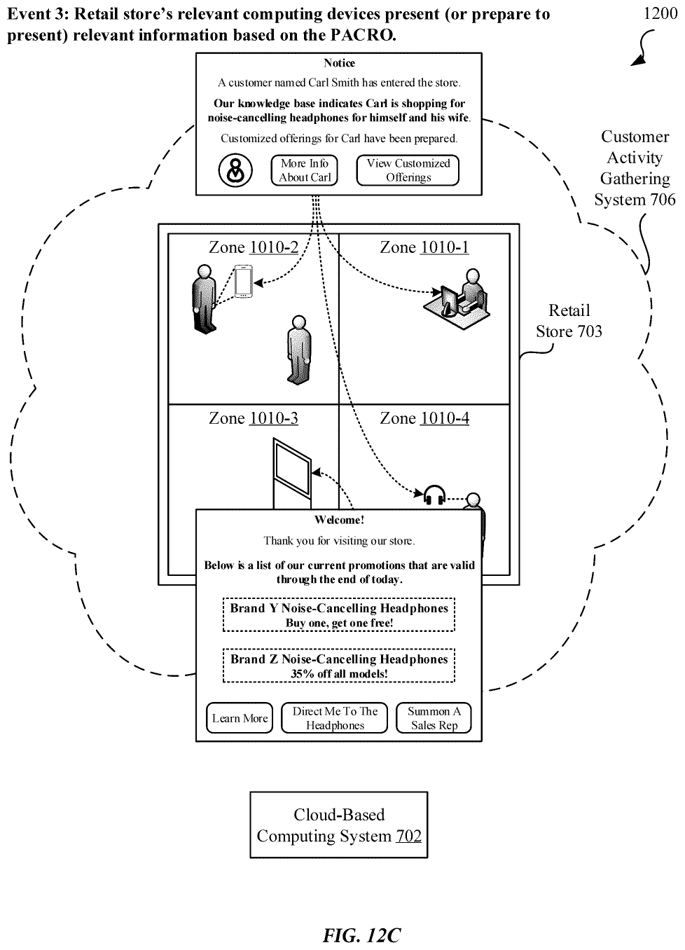

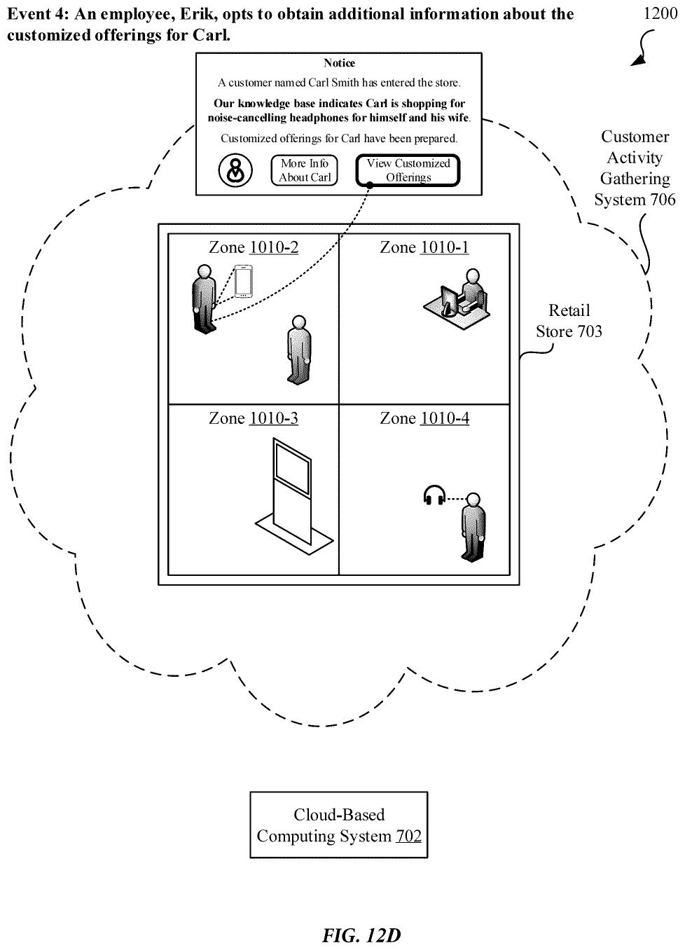

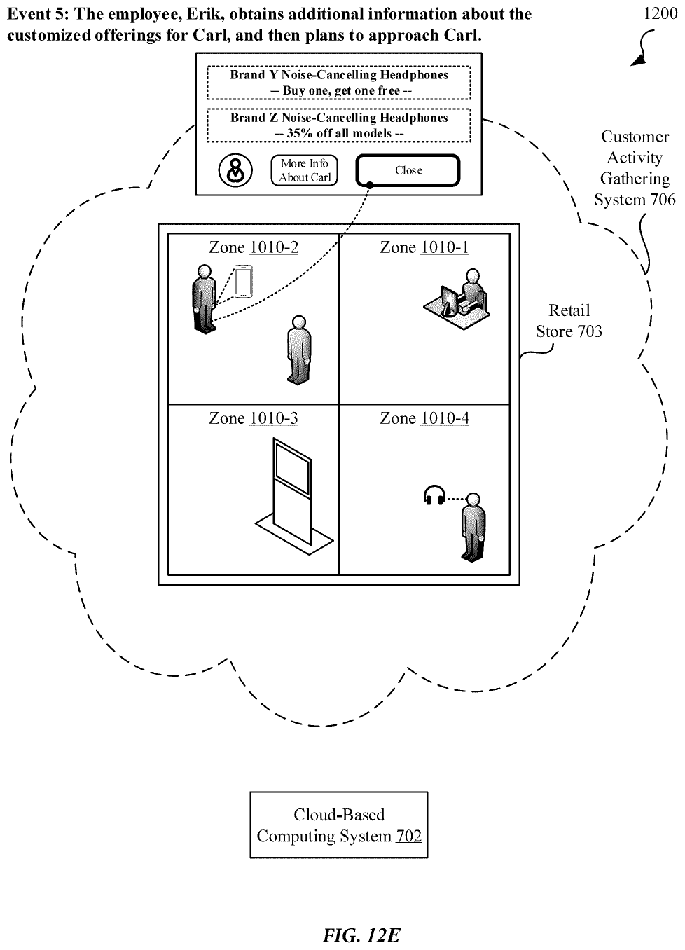

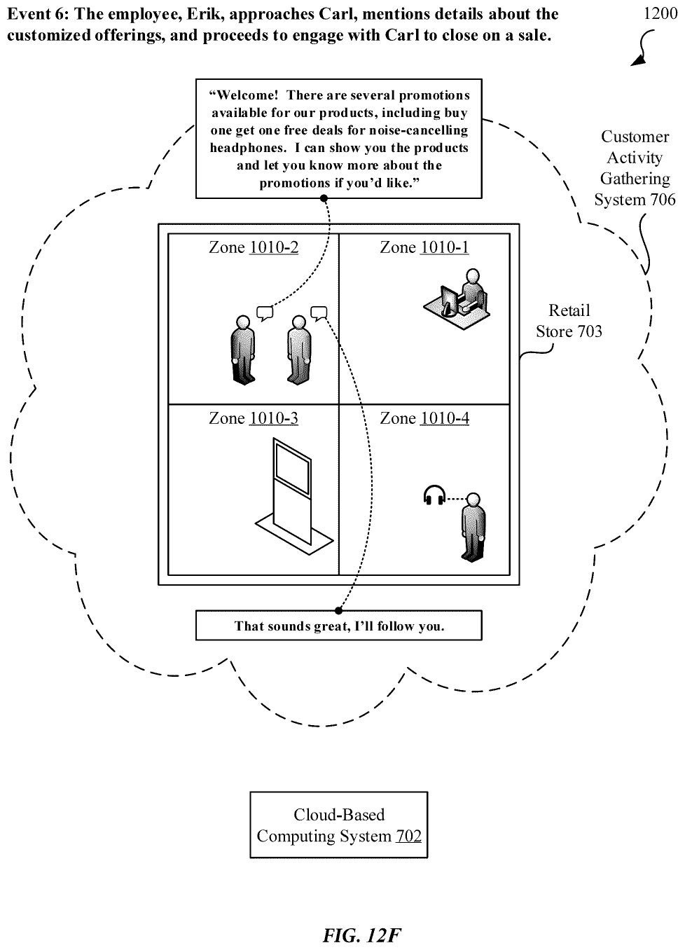

FIGS. 11 through 12, discussed below, and the various embodiments used to describe the principles of this disclosure are by way of illustration only and should not be construed in any way to limit the scope of the disclosure. As shown in FIG. 11, a method 1100 for generating customized offerings for prospective customers of retail stores 703 can begin at step 1102, where the cloud-based computing system 702 obtains first information associated with a prospective customer of a retail store 703. As described herein, the first information can include, for example, any information stored in the customer profile 806 associated with the prospective customer, consistent with the scope of this disclosure.

At step 1104, the cloud-based computing system 702 obtains second information related to extant offerings associated with the retail store 703. As described herein, the second information can include, for example, any information stored in the retail store profile 814 of the retail store 703, such as product/service offerings 816 that describe available products and/or services, if any, that are purchasable through the retail store 703, extant promotions associated with the offerings, and so on.

At step 1106, the cloud-based computing system 702 generates, based on the first and second information, third information related to one or more customized offerings for the prospective customer. To generate the customized offerings for the prospective customer, the cloud-based computing system 702 can employ one or more artificial intelligence (AI) models that have been trained to receive the first and second information (as well as any other relevant information) as inputs and provide customized offerings (i.e., the third information) as output. However, non-AI-based approaches can be utilized to implement the same or similar functionalities as the AI-based approaches described herein.

According to some embodiments, a given customized offering can relate to a product or service that (1) is of interest, may be of interest, etc., to the prospective customer (e.g., as indicated in, derived from, etc., the first information), and (2) that is available, can be available, will be available, etc., through the retail store 703 (e.g., as indicated in, derived from, etc., the second information). For example, if the first information indicates that the prospective customer is interested in swim goggles, and the second information indicates that the retail store 703 offers different swim goggles for sale, then one or more customized offerings can be generated and linked to the different swim goggles. In another example, if the first information indicates that the prospective customer is experiencing neck pain from weightlifting, and the second information indicates that the retail store offers (or can offer) a collection of athletic massages, then one or more customized offerings can be generated and linked to the athletic massages. In any case—and, as described in greater detail below—one or more promotions can be generated based on the first, second, and/or other information, and applied to the product(s) or service(s) linked to the customized offering(s).

According to some embodiments, a given promotion for a product or service can constitute a customized price, a customized financing option, a customized inventory count, a customized bundle option, a customized reward for exercising the customized offering, a customized available time limit for exercising the customized offering, and so on, for the product or service (and/or other products/services, where appropriate). The foregoing customizations should not be construed as limiting, and the customizations can pertain to any manner in which the product or service (and/or other products/services, where appropriate) can be acquired, at any level of granularity, consistent with the scope of this disclosure. Additionally, such customizations can be based on any information included in the first, second, or other information, at any level of granularity, consistent with the scope of this disclosure.

Consider, for example, a scenario in which a prospective customer, a mother, has demonstrated an interest in acquiring bicycles for one or more of her three children. Consider further that the retail store 703 (discussed throughout steps 1102-1112) not only carries bicycles for children, but has an excessive inventory of the bicycles to the extent that it would be ideal to begin offloading the bicycles at an accelerated rate. In this scenario, the cloud-based computing system 702 can generate one or more customized offerings that may encourage the mother to purchase the bicycles from the retail store 703 in a manner that also remains within economic, operational, etc., boundaries that are desirable to the retail store 703. According to some embodiments, the economic boundaries can be managed under any number of rule sets associated with the retail store 703, the product/service offerings 816 associated with the retail store 703, and so on. For example, a given rule set may indicate it would be acceptable for the retail store to sell a second bicycle at a 75% discounted price when a first bicycle is purchased at retail price, and to sell a third bicycle at a 50% discounted price when the second and first bicycles are purchased at the aforementioned prices. In another example, a given rule set may indicate it would be acceptable to provide free, discounted, etc., bicycle gear (e.g., helmets, gloves, etc.) with the purchase of one or more bicycles. Again, the foregoing examples are not meant to be limiting, and any number of rule sets can be established to enable the cloud-based computing system 702 to generate customized offerings that will entice prospective customers to purchase products/services while remaining within boundaries that are desirable to the retail store 703.

At step 1108, the cloud-based computing system 702 generates, based on the first and third information, a proximity-activated customer retail offer (PACRO 818) for the prospective customer, consistent with the techniques described herein. The PACRO 818 can also be based on the second information, such that the PACRO 818 effectively includes information about the prospective customer, information about the products/services that may be of interest to the prospective customer and are available through the retail store 703, information about customized offerings pertaining to the products/services, and so on. According to some embodiments, the PACRO 818 can include instructions about the order in which the customized offerings should be presented to the prospective customer. For example, the customized offerings can be prioritized from the most beneficial to the least beneficial with respect to the retail store 703. In this manner, increasing levels of concessions can be made to the prospective customer until one concession is accepted, the foregoing of which can help avoid making unnecessary concessions to the prospective customer.

At step 1110, the cloud-based computing system 702 identifies at least one mechanism through which the prospective customer can be engaged in a manner consistent with the PACRO 818, consistent with the techniques described herein. At step 1112, the cloud-based computing system 702, using the at least one mechanism and the PACRO 818, enables at least one engagement with the prospective customer, consistent with the techniques described herein.

Accordingly, FIG. 11 illustrates a method 1100 for generating customized offerings for prospective customers of retail stores 703, according to certain embodiments of this disclosure. Additionally, FIGS. 12A-12F illustrate conceptual diagrams 1200 that provide additional context about how the techniques described herein can be utilized, according to certain embodiments of this disclosure. The example setup illustrated in FIGS. 12A-12F is similar to the setup illustrated in FIGS. 10A-10I. In particular, the retail store 703 is segmented into zones 1010-1, 1010-2, 1010-3, and 1010-4. The first employee, Sara, is located in the zone 1010-1, and is operating a first retail store computing device 704 (e.g., a desktop computer). The second employee, Erik, is located in the zone 1010-2, and is operating a second retail store computing device 704 (e.g., a mobile computing device). The third employee, Craig, is located in the zone 1010-4, and is operating a fourth retail store computing device 704 (e.g., a wireless radio system connected to a headset). Additionally, the third retail store computing device 704—e.g., a kiosk—is located in the zone 1010-3, and includes a display device, a speaker, and input controls. The aforementioned setup can be reflected in the retail store profile 814 associated with the retail store 703.

In the example illustrated in FIG. 12A, the retail store 703 is associated with a customer activity gathering system 706 capable of detecting prospective customers that are in proximity to the retail store 703, that have entered the retail store 703, and so on. As shown in FIG. 12A, a first event involves a prospective customer, Carl, entering the retail store 703 and being detected by the customer activity gathering system 706 (consistent with the techniques described herein). Turning now to FIG. 12B, a second event involves the customer activity gathering system 706 providing, to the cloud-based computing system 702, information about Carl (e.g., in the form of customer activity information 812). In turn, the cloud-based computing system 702 generates a PACRO 818 (e.g., in accordance with the PACRO 818 generation techniques described herein) and transmits the PACRO 818 to the four retail store computing devices 704.

As shown in FIG. 12C, the relevant retail store computing devices 704 present—or prepare to present—information based on the PACRO 818, consistent with the techniques described herein. For example, in accordance with the PACRO 818, the retail store computing devices 704 notify the respective employees that Carl has entered the retail store 703, that he is interested in noise-cancelling headphones for himself and his wife, and that customized offerings have been prepared for Carl. The retail store computing devices 704 also enable the employees to view more information about Carl, and to view details about the customized offerings.

Additionally, the PACRO 818 that is delivered to the fourth retail store computing device 704 utilized by prospective customers—i.e., the kiosk—includes information about Carl, a welcome message, information about the customized offerings, information about a navigational path through the store from the kiosk to the noise-cancelling headphones, and so on. In this regard, the kiosk can update a configuration to actively search for Carl's presence (e.g., using any of the recognition techniques described herein) so that the kiosk can display information when Carl is proximate to the kiosk—which, as shown in FIG. 12C, includes information about at least two of the customized promotions, as well as an option to summon a sales representative.

Turning now to FIG. 12D, a fourth event involves the employee Erik opting to obtain additional information about the customized offerings for Carl. In turn, and as shown in FIG. 12E, a fifth event involves Erik obtaining, analyzing, etc., the additional information about the customized offerings for Carl, and then planning to approach Carl. As described herein, the PACRO 818 can also include guidance that is customized for Erik, e.g., motivational language, incentives for closing the sale, and so on. Turning now to FIG. 12F, a sixth event involves Erik approaching Carl with the customized offerings in mind. Erik then interfaces with Carl by greeting Carl, describing some of the promotions to Carl, and offering to show Carl the noise-cancelling headphones. From that point on, a potential sale of noise-cancelling headphones can be carried out.

In addition to providing notifications as described above, the present disclosure may provide notification of suspicious people in public spaces. For example, the present disclosure may enable the provision of notifications to relevant users and/or authorities, including law enforcement and private security, of criminals in subways. In addition, given the high correlation of people who jump turnstiles in public transportation networks and people with outstanding warrants, the present disclosure may detect people jumping turnstiles and notify law enforcement and/or private security. As a further example, the preset disclosure may provide notifications of intrusion in restricted areas of a hospital.

Consistent with the above disclosure, the examples of systems and method enumerated in the following clauses are specifically contemplated and are intended as a non-limiting set of examples.

Clause 1. A method for managing proximity-activated customer retail offers (PACROS) for prospective customers of retail stores, the method comprising, by at least one computing device:
detecting that a prospective customer has satisfied a threshold likelihood of visiting a retail store;
obtaining first information associated with the prospective customer;
obtaining second information related to offerings associated with the retail store;
generating, based on the first and second information, a PACRO for the prospective customer;
identifying at least one mechanism through which the prospective customer can be engaged in a manner consistent with the PACRO; and
using the at least one mechanism and the PACRO, enabling at least one engagement with the prospective customer.

Clause 2. The method of any clause herein, wherein detecting that the prospective customer has satisfied the threshold likelihood of visiting the retail store comprises:
identifying that a vehicle associated with the prospective customer has entered a first geofence associated with the retail store;
identifying that the prospective customer has entered a second geofence associated with the retail store;
identifying that the prospective customer has engaged in at least one activity that suggests the prospective customer may intend to visit the retail store; or
some combination thereof.

Clause 3. The method of any clause herein, wherein:
the vehicle is identified using optical character recognition techniques to identify a license plate of the vehicle;
the prospective customer is identified using eye, facial, voice, finger, and/or gait biometric recognition techniques, and/or techniques for detecting computing devices associated with the prospective customer; and
the threshold likelihood of the prospective customer entering the retail store is satisfied based on:
   the prospective customer selecting, on a website or a mobile application associated with the retail store, one or more options to:
      view hours and/or location information associated with the retail store,
      view inventory information associated with the retail store, or
      some combination thereof;
   the prospective customer contacting customer service associated with the retail store;
   the prospective customer making at least one website, social media, or other mobile-based post that mentions the offerings, the retail store, an entity that owns the retail store, or some combination thereof; or
   some combination thereof.

Clause 4. The method of any clause herein, wherein the first information associated with the prospective customer comprises:
background check information, geographical information, educational information, employment history information, social network activity information, or some combination thereof;
products and/or services in which the prospective customer has satisfied a threshold level of interest; or
some combination thereof.

Clause 5. The method of any clause herein, wherein the second information related to offerings associated with the retail store comprises:
available products and/or services, if any, that are purchasable through the retail store, and that satisfy a similarity threshold when compared to the products, services, or some combination thereof, in which the prospective customer has satisfied the threshold level of interest;
extant promotions associated with the offerings;
dynamically-generated promotions; or
some combination thereof.

Clause 6. The method of any clause herein, wherein the at least one mechanism comprises:
at least one computing device operated by at least one employee of the retail store;
at least one human-computer interface (HCI) associated with the retail store; or
some combination thereof.

Clause 7. The method of any clause herein, wherein the at least one employee is identified based on:
satisfying a demographic or psychographic similarity threshold when compared to the prospective customer;
satisfying one or more knowledge thresholds about at least one offering on which the PACRO is based; or
some combination thereof.

Clause 8. The method of any clause herein, further comprising, prior to enabling the at least one engagement with the prospective customer using the at least one employee:
gathering information associated with the at least one employee; and based on the information associated with the at least one employee, customizing the PACRO.

Clause 9. The method of any clause herein, wherein customizing the PACRO comprises:
selecting one or more formats for content included in the PACRO;
including, in the PACRO:
   motivational language that is likely to be effective in motivating the at least one employee,
   at least one compensation incentive based on the information associated with the at least one employee and/or the PACRO,
   dynamic routing instructions based on respective locations of the prospective customer and the at least one employee, or
   some combination thereof;
assigning a priority to the PACRO based on other PACROS, if any, that the at least one employee is currently servicing; or
some combination thereof.

Clause 10. The method of any clause herein, wherein the PACRO comprises:
audio content;
video content;
document content;
haptic content;
other multimedia or biometric content; or
some combination thereof.

Clause 11. A non-transitory computer readable storage medium configured to store instructions that, when executed by at least one processor included in a computing device, cause the computing device to manage proximity-activated customer retail offers (PACROs) for prospective customers of retail stores, by carrying out steps that include:
detecting that a prospective customer has satisfied a threshold likelihood of visiting a retail store;
obtaining first information associated with the prospective customer;
obtaining second information related to offerings associated with the retail store;
generating, based on the first and second information, a PACRO for the prospective customer;
identifying at least one mechanism through which the prospective customer can be engaged in a manner consistent with the PACRO; and
using the at least one mechanism and the PACRO, enabling at least one engagement with the prospective customer.

Clause 12. The non-transitory computer readable storage medium of any clause herein, wherein detecting that the prospective customer has satisfied the threshold likelihood of visiting the retail store comprises:
identifying that a vehicle associated with the prospective customer has entered a first geofence associated with the retail store;
identifying that the prospective customer has entered a second geofence associated with the retail store;
identifying that the prospective customer has engaged in at least one activity that suggests the prospective customer may intend to visit the retail store; or
some combination thereof.

Clause 13. The non-transitory computer readable storage medium of any clause herein, wherein:
the vehicle is identified using optical character recognition techniques to identify a license plate of the vehicle;
the prospective customer is identified using eye, facial, voice, finger, and/or gait biometric recognition techniques, and/or techniques for detecting computing devices associated with the prospective customer; and
the threshold likelihood of the prospective customer entering the retail store is satisfied based on:
   the prospective customer selecting, on a website or a mobile application associated with the retail store, one or more options to:
      view hours and/or location information associated with the retail store,
      view inventory information associated with the retail store, or
      some combination thereof;
   the prospective customer contacting customer service associated with the retail store;
   the prospective customer making at least one website, social media, or other mobile-based post that mentions the offerings, the retail store, an entity that owns the retail store, or some combination thereof; or
   some combination thereof.

Clause 14. The non-transitory computer readable storage medium of any clause herein, wherein the first information associated with the prospective customer comprises:
background check information, geographical information, educational information, employment history information, social network activity information, or some combination thereof;
products and/or services in which the prospective customer has satisfied a threshold level of interest; or
some combination thereof.

Clause 15. The non-transitory computer readable storage medium of any clause herein, wherein the second information related to offerings associated with the retail store comprises:
available products and/or services, if any, that are purchasable through the retail store, and that satisfy a similarity threshold when compared to the products, services, or some combination thereof, in which the prospective customer has satisfied the threshold level of interest;
extant promotions associated with the offerings; or
some combination thereof.

Clause 16. A computing device configured to manage proximity-activated customer retail offers (PACROs) for prospective customers of retail stores, the computing device comprising:
at least one processor; and
at least one memory storing instructions that, when executed by the at least one processor, cause the computing device to carry out steps that include:
   detecting that a prospective customer has satisfied a threshold likelihood of visiting a retail store;
   obtaining first information associated with the prospective customer;
   obtaining second information related to offerings associated with the retail store;
   generating, based on the first and second information, a PACRO for the prospective customer;
   identifying at least one mechanism through which the prospective customer can be engaged in a manner consistent with the PACRO; and
   using the at least one mechanism and the PACRO, enabling at least one engagement with the prospective customer.

Clause 17. The computing device of any clause herein, wherein detecting that the prospective customer has satisfied the threshold likelihood of visiting the retail store comprises:
identifying that a vehicle associated with the prospective customer has entered a first geofence associated with the retail store;
identifying that the prospective customer has entered a second geofence associated with the retail store;
identifying that the prospective customer has engaged in at least one activity that suggests the prospective customer may intend to visit the retail store; or
some combination thereof.

Clause 18. The computing device of any clause herein, wherein:
the vehicle is identified using optical character recognition techniques to identify a license plate of the vehicle;
the prospective customer is identified using eye, facial, voice, finger, and/or gait biometric recognition techniques, and/or techniques for detecting computing devices associated with the prospective customer; and
the threshold likelihood of the prospective customer entering the retail store is satisfied based on:
   the prospective customer selecting, on a website or a mobile application associated with the retail store, one or more options to:
      view hours and/or location information associated with the retail store,
      view inventory information associated with the retail store, or
      some combination thereof;
   the prospective customer contacting customer service associated with the retail store;
   the prospective customer making at least one website, social media, or other mobile-based post that mentions the offerings, the retail store, an entity that owns the retail store, or some combination thereof; or
   some combination thereof.

Clause 19. The computing device of any clause herein, wherein the first information associated with the prospective customer comprises:
background check information, geographical information, educational information, employment history information, social network activity information, or some combination thereof;
products and/or services in which the prospective customer has satisfied a threshold level of interest; or
some combination thereof.

Clause 20. The computing device of any clause herein, wherein the second information related to offerings associated with the retail store comprises:
available products and/or services, if any, that are purchasable through the retail store, and that satisfy a similarity threshold when compared to the products, services, or some combination thereof, in which the prospective customer has satisfied the threshold level of interest;
extant promotions associated with the offerings; or
some combination thereof.

Clause 21. A method for generating customized offerings for prospective customers of retail stores, the method comprising, by at least one computing device:
obtaining first information associated with a prospective customer of a retail store;
obtaining second information related to extant offerings associated with the retail store;
generating, based on the first and second information, third information related to one or more customized offerings for the prospective customer;
generating, based on the first and third information, a proximity-activated customer retail offer (PACRO) for the prospective customer;
identifying at least one mechanism through which the prospective customer can be engaged in a manner consistent with the PACRO; and
using the at least one mechanism and the PACRO, enabling at least one engagement with the prospective customer.

Clause 22. The method of any clause herein, wherein the PACRO is further generated based on the second information related to extant offerings associated with the retail store.

Clause 23. The method of any clause herein, further comprising, prior to obtaining the first information:
detecting that the prospective customer has satisfied a threshold likelihood of visiting the retail store.

Clause 24. The method of any clause herein, wherein detecting that the prospective customer has satisfied the threshold likelihood of visiting the retail store comprises:
identifying that a vehicle associated with the prospective customer has entered a first geofence associated with the retail store;
identifying that the prospective customer has entered a second geofence associated with the retail store;
identifying that the prospective customer has engaged in at least one activity that suggests the prospective customer may intend to visit the retail store; or
some combination thereof.

Clause 25. The method of any clause herein, wherein the first information associated with the prospective customer comprises:
background check information, geographical information, educational information, employment history information, social network activity information, or some combination thereof;
products and/or services in which the prospective customer has satisfied a threshold level of interest; or
some combination thereof.

Clause 26. The method of any clause herein, wherein the second information related to extant offerings associated with the retail store comprises:
available products and/or services, if any, that are purchasable through the retail store, and that satisfy a similarity threshold when compared to the products, services, or some combination thereof, in which the prospective customer has satisfied the threshold level of interest; or
some combination thereof.

Clause 27. The method of any clause herein, wherein each customized offering of the one or more customized offerings is associated with a respective available product or service among the available products or services, and wherein generating the customized offering comprises establishing, for the respective available product or service:
a customized price, a customized financing option, a customized inventory count, a customized bundle option, a customized reward for exercising the customized offering, a customized available time limit for exercising the customized offering, or some combination thereof.

Clause 28. A non-transitory computer readable storage medium configured to store instructions that, when executed by at least one processor included in a computing device, cause the computing device to generate customized offerings for prospective customers of retail stores, by carrying out steps that include:
obtaining first information associated with a prospective customer of a retail store;
obtaining second information related to extant offerings associated with the retail store;
generating, based on the first and second information, third information related to one or more customized offerings for the prospective customer;
generating, based on the first and third information, a proximity-activated customer retail offer (PACRO) for the prospective customer;
identifying at least one mechanism through which the prospective customer can be engaged in a manner consistent with the PACRO; and
using the at least one mechanism and the PACRO, enabling at least one engagement with the prospective customer.

Clause 29. The non-transitory computer readable storage medium of any clause herein, wherein the PACRO is further generated based on the second information related to extant offerings associated with the retail store.

Clause 30. The non-transitory computer readable storage medium of any clause herein, wherein the steps further include, prior to obtaining the first information:
detecting that the prospective customer has satisfied a threshold likelihood of visiting the retail store.

Clause 31. The non-transitory computer readable storage medium of any clause herein, wherein detecting that the prospective customer has satisfied the threshold likelihood of visiting the retail store comprises:
identifying that a vehicle associated with the prospective customer has entered a first geofence associated with the retail store;
identifying that the prospective customer has entered a second geofence associated with the retail store;
identifying that the prospective customer has engaged in at least one activity that suggests the prospective customer may intend to visit the retail store; or
some combination thereof.

Clause 32. The non-transitory computer readable storage medium of any clause herein, wherein the first information associated with the prospective customer comprises:
background check information, geographical information, educational information, employment history information, social network activity information, or some combination thereof;
products and/or services in which the prospective customer has satisfied a threshold level of interest; or
some combination thereof.

Clause 33. The non-transitory computer readable storage medium of any clause herein, wherein the second information related to extant offerings associated with the retail store comprises:
available products and/or services, if any, that are purchasable through the retail store, and that satisfy a similarity threshold when compared to the products, services, or some combination thereof, in which the prospective customer has satisfied the threshold level of interest; or
some combination thereof.

Clause 34. The non-transitory computer readable storage medium of any clause herein, wherein each customized offering of the one or more customized offerings is associated with a respective available product or service among the available products or services, and wherein generating the customized offering comprises establishing, for the respective available product or service:
a customized price, a customized financing option, a customized inventory count, a customized bundle option, a customized reward for exercising the customized offering, a customized available time limit for exercising the customized offering, or some combination thereof.

Clause 35. A computing device configured to generate customized offerings for prospective customers of retail stores, the computing device comprising:
at least one processor; and
at least one memory configured to store instructions that, when executed by the at least one processor, cause the computing device to carry out steps that include:
   obtaining first information associated with a prospective customer of a retail store;
   obtaining second information related to extant offerings associated with the retail store;
   generating, based on the first and second information, third information related to one or more customized offerings for the prospective customer;
   generating, based on the first and third information, a proximity-activated customer retail offer (PACRO) for the prospective customer;
   identifying at least one mechanism through which the prospective customer can be engaged in a manner consistent with the PACRO; and
   using the at least one mechanism and the PACRO, enabling at least one engagement with the prospective customer.

Clause 36. The computing device of any clause herein, wherein the PACRO is further generated based on the second information related to extant offerings associated with the retail store.

Clause 37. The computing device of claim 35, wherein the steps further include, prior to obtaining the first information:
detecting that the prospective customer has satisfied a threshold likelihood of visiting the retail store.

Clause 38. The computing device of any clause herein, wherein detecting that the prospective customer has satisfied the threshold likelihood of visiting the retail store comprises:
identifying that a vehicle associated with the prospective customer has entered a first geofence associated with the retail store;
identifying that the prospective customer has entered a second geofence associated with the retail store;
identifying that the prospective customer has engaged in at least one activity that suggests the prospective customer may intend to visit the retail store; or
some combination thereof.

Clause 39. The computing device of any clause herein, wherein the first information associated with the prospective customer comprises:
background check information, geographical information, educational information, employment history information, social network activity information, or some combination thereof;
products and/or services in which the prospective customer has satisfied a threshold level of interest; or
some combination thereof.

Clause 40. The computing device of any clause herein, wherein the second information related to extant offerings associated with the retail store comprises:
available products and/or services, if any, that are purchasable through the retail store, and that satisfy a similarity threshold when compared to the products, services, or some combination thereof, in which the prospective customer has satisfied the threshold level of interest; or
some combination thereof.

Clause 41. The computing device of any clause herein, wherein each customized offering of the one or more customized offerings is associated with a respective available product or service among the available products or services, and wherein generating the customized offering comprises establishing, for the respective available product or service:
a customized price, a customized financing option, a customized inventory count, a customized bundle option, a customized reward for exercising the customized offering, a customized available time limit for exercising the customized offering, or some combination thereof.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle.

What is claimed is:

1. A method for managing proximity-activated customer retail offers (PACROs) for prospective customers of retail stores, the method comprising, by at least one computing device:
detecting that a prospective customer has satisfied a threshold likelihood of visiting a retail store;
obtaining first information associated with the prospective customer;
obtaining second information related to offerings associated with the retail store;
generating, based on the first and second information, a PACRO for the prospective customer;
identifying at least one mechanism through which the prospective customer can be engaged in a manner consistent with the PACRO; and
using the at least one mechanism and the PACRO, enabling at least one engagement with the prospective customer.

2. The method of claim 1, wherein detecting that the prospective customer has satisfied the threshold likelihood of visiting the retail store comprises:
identifying that a vehicle associated with the prospective customer has entered a first geofence associated with the retail store;
identifying that the prospective customer has entered a second geofence associated with the retail store;
identifying that the prospective customer has engaged in at least one activity that suggests the prospective customer may intend to visit the retail store; or
some combination thereof.

3. The method of claim 2, wherein:
the vehicle is identified using optical character recognition techniques to identify a license plate of the vehicle;
the prospective customer is identified using eye, facial, voice, finger, and/or gait biometric recognition techniques, and/or techniques for detecting computing devices associated with the prospective customer; and
the threshold likelihood of the prospective customer entering the retail store is satisfied based on:
the prospective customer selecting, on a website or a mobile application associated with the retail store, one or more options to:
view hours and/or location information associated with the retail store,
view inventory information associated with the retail store, or
some combination thereof;
the prospective customer contacting customer service associated with the retail store;
the prospective customer making at least one website, social media, or other mobile-based post that mentions the offerings, the retail store, an entity that owns the retail store, or some combination thereof; or
some combination thereof.

4. The method of claim 1, wherein the first information associated with the prospective customer comprises:
background check information, geographical information, educational information, employment history information, social network activity information, or some combination thereof;
products and/or services in which the prospective customer has satisfied a threshold level of interest; or
some combination thereof.

5. The method of claim 4, wherein the second information related to offerings associated with the retail store comprises:
available products and/or services, if any, that are purchasable through the retail store, and that satisfy a similarity threshold when compared to the products, services, or some combination thereof, in which the prospective customer has satisfied the threshold level of interest;
extant promotions associated with the offerings;
dynamically-generated promotions; or
some combination thereof.

6. The method of claim 1, wherein the at least one mechanism comprises:
at least one computing device operated by at least one employee of the retail store;
at least one human-computer interface (HCI) associated with the retail store; or
some combination thereof.

7. The method of claim 6, wherein the at least one employee is identified based on:
satisfying a demographic or psychographic similarity threshold when compared to the prospective customer;
satisfying one or more knowledge thresholds about at least one offering on which the PACRO is based; or
some combination thereof.

8. The method of claim 6, further comprising, prior to enabling the at least one engagement with the prospective customer using the at least one employee:
gathering information associated with the at least one employee; and
based on the information associated with the at least one employee, customizing the PACRO.

9. The method of claim 8, wherein customizing the PACRO comprises:
selecting one or more formats for content included in the PACRO;
including, in the PACRO:
motivational language that is likely to be effective in motivating the at least one employee,
at least one compensation incentive based on the information associated with the at least one employee and/or the PACRO,
dynamic routing instructions based on respective locations of the prospective customer and the at least one employee, or
some combination thereof;
assigning a priority to the PACRO based on other PACROS, if any, that the at least one employee is currently servicing; or
some combination thereof.

10. The method of claim 1, wherein the PACRO comprises:
audio content;
video content;
document content;
haptic content;
other multimedia or biometric content; or
some combination thereof.

11. A non-transitory computer readable storage medium configured to store instructions that, when executed by at least one processor included in a computing device, cause the computing device to manage proximity-activated customer retail offers (PACROs) for prospective customers of retail stores, by carrying out steps that include:
detecting that a prospective customer has satisfied a threshold likelihood of visiting a retail store;
obtaining first information associated with the prospective customer;
obtaining second information related to offerings associated with the retail store;
generating, based on the first and second information, a PACRO for the prospective customer;
identifying at least one mechanism through which the prospective customer can be engaged in a manner consistent with the PACRO; and
using the at least one mechanism and the PACRO, enabling at least one engagement with the prospective customer.

12. The non-transitory computer readable storage medium of claim 11, wherein detecting that the prospective customer has satisfied the threshold likelihood of visiting the retail store comprises:
identifying that a vehicle associated with the prospective customer has entered a first geofence associated with the retail store;
identifying that the prospective customer has entered a second geofence associated with the retail store;
identifying that the prospective customer has engaged in at least one activity that suggests the prospective customer may intend to visit the retail store; or
some combination thereof.

13. The non-transitory computer readable storage medium of claim 12, wherein:
the vehicle is identified using optical character recognition techniques to identify a license plate of the vehicle;
the prospective customer is identified using eye, facial, voice, finger, and/or gait biometric recognition techniques, and/or techniques for detecting computing devices associated with the prospective customer; and
the threshold likelihood of the prospective customer entering the retail store is satisfied based on:
the prospective customer selecting, on a website or a mobile application associated with the retail store, one or more options to:
view hours and/or location information associated with the retail store,
view inventory information associated with the retail store, or
some combination thereof;
the prospective customer contacting customer service associated with the retail store;
the prospective customer making at least one website, social media, or other mobile-based post that mentions the offerings, the retail store, an entity that owns the retail store, or some combination thereof; or
some combination thereof.

14. The non-transitory computer readable storage medium of claim 11, wherein the first information associated with the prospective customer comprises:
background check information, geographical information, educational information, employment history information, social network activity information, or some combination thereof;
products and/or services in which the prospective customer has satisfied a threshold level of interest; or
some combination thereof.

15. The non-transitory computer readable storage medium of claim 14, wherein the second information related to offerings associated with the retail store comprises:
available products and/or services, if any, that are purchasable through the retail store, and that satisfy a similarity threshold when compared to the products, services, or some combination thereof, in which the prospective customer has satisfied the threshold level of interest;
extant promotions associated with the offerings; or
some combination thereof.

16. A computing device configured to manage proximity-activated customer retail offers (PACROs) for prospective customers of retail stores, the computing device comprising:
at least one processor; and
at least one memory storing instructions that, when executed by the at least one processor,
cause the computing device to carry out steps that include:
detecting that a prospective customer has satisfied a threshold likelihood of visiting a retail store;
obtaining first information associated with the prospective customer;
obtaining second information related to offerings associated with the retail store;
generating, based on the first and second information, a PACRO for the prospective customer;
identifying at least one mechanism through which the prospective customer can be engaged in a manner consistent with the PACRO; and
using the at least one mechanism and the PACRO, enabling at least one engagement with the prospective customer.

17. The computing device of claim 16, wherein detecting that the prospective customer has satisfied the threshold likelihood of visiting the retail store comprises:
identifying that a vehicle associated with the prospective customer has entered a first geofence associated with the retail store;
identifying that the prospective customer has entered a second geofence associated with the retail store;
identifying that the prospective customer has engaged in at least one activity that suggests the prospective customer may intend to visit the retail store; or
some combination thereof.

18. The computing device of claim 17, wherein:
the vehicle is identified using optical character recognition techniques to identify a license plate of the vehicle;
the prospective customer is identified using eye, facial, voice, finger, and/or gait biometric recognition techniques, and/or techniques for detecting computing devices associated with the prospective customer; and
the threshold likelihood of the prospective customer entering the retail store is satisfied based on:
the prospective customer selecting, on a website or a mobile application associated with the retail store, one or more options to:
view hours and/or location information associated with the retail store,
view inventory information associated with the retail store, or
some combination thereof;
the prospective customer contacting customer service associated with the retail store;
the prospective customer making at least one website, social media, or other mobile-based post that mentions the offerings, the retail store, an entity that owns the retail store, or some combination thereof; or
some combination thereof.

19. The computing device of claim 16, wherein the first information associated with the prospective customer comprises:
background check information, geographical information, educational information, employment history information, social network activity information, or some combination thereof;
products and/or services in which the prospective customer has satisfied a threshold level of interest; or
some combination thereof.

20. The computing device of claim 19, wherein the second information related to offerings associated with the retail store comprises:
available products and/or services, if any, that are purchasable through the retail store, and that satisfy a similarity threshold when compared to the products, services, or some combination thereof, in which the prospective customer has satisfied the threshold level of interest;
extant promotions associated with the offerings; or
some combination thereof.
